(19) United States
(12) Patent Application Publication
(10) Pub. No.: US 2025/0344198 A1
(43) Pub. Date: Nov. 6, 2025

(54) SIDELINK ASSISTED BEAM BLOCKAGE PREDICTION

(71) Applicant: QUALCOMM Incorporated, San Diego, CA (US)

(72) Inventors: Qiaoyu Li, Beijing (CN); Mahmoud Taherzadeh Boroujeni, San Diego, CA (US); Hamed Pezeshki, San Diego, CA (US); Tao Luo, San Diego, CA (US)

(21) Appl. No.: 18/861,503

(22) PCT Filed: Jun. 28, 2022
(86) PCT No.: PCT/CN2022/101762

§ 371 Date: Oct. 29, 2024

(51) Int. Cl. H04W 72/044; H04W 24/02

(52) U.S. Cl. CPC H04W 72/046; H04W 24/02

(57) ABSTRACT

This disclosure provides systems, methods, and devices for wireless communication that support sidelink assisted beam blockage prediction operations. In a first aspect, an apparatus includes at least one processor and a memory coupled to the at least one processor. The at least one processor is configured to obtain measurement information associated with at least one downlink serving cell; and transmit beam blockage prediction information to a second network node, wherein the beam blockage prediction information is based on the measurement information, and wherein the beam blockage prediction information is indicative of at least one predicted beam blockage associated with the at least one downlink serving cell. Other aspects and features are also claimed and described.

### TECHNICAL FIELD

Aspects of the present disclosure relate generally to wireless communication systems, and more particularly, to beam blockage mitigation techniques. Some features may enable and provide improved communications, including using sidelink channels to provide predicted blockage information and mitigation information for other channels in a network.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus includes at least one processor and a memory coupled to the at least one processor. The at least one processor is configured to obtain measurement information associated with at least one downlink serving cell; and transmit beam blockage prediction information to a second network node, wherein the beam blockage prediction information is based on the measurement information, and wherein the beam blockage prediction information is indicative of at least one predicted beam blockage associated with the at least one downlink serving cell.

In an additional aspect of the disclosure, an apparatus includes at least one processor and a memory coupled to the at least one processor. The at least one processor is configured to receive, from a second network node via a sidelink channel, beam blockage prediction information, wherein the beam blockage prediction information is indicative of at least one predicted beam blockage for the second network node and is associated with at least one downlink serving cell; and transmit the beam blockage prediction information to a third network node via an uplink channel.

In an additional aspect of the disclosure, an apparatus includes at least one processor and a memory coupled to the at least one processor. The at least one processor is configured to receive beam blockage prediction information from a second network node via an uplink channel, wherein the beam blockage prediction information is indicative of a predicted beam blockage instance for a third network node; and transmit beam blockage response information to the second network node via a downlink channel, wherein the beam blockage prediction information includes an indication for a beam blockage recovery operation for the third network node.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a timing diagram illustrating an example of a wireless communication system experiencing beam blockage according to one or more aspects.

FIG. 4 is a block diagram illustrating an example wireless communication system that supports sidelink assisted beam blockage prediction according to one or more aspects.

FIG. 5 is a timing diagram illustrating a wireless communication system that supports sidelink assisted beam blockage prediction according to one or more aspects.

FIG. 6 is a timing diagram illustrating a wireless communication system that supports sidelink assisted beam blockage prediction according to one or more aspects.

FIG. 7 is a flow diagram illustrating an example process that supports sidelink assisted beam blockage prediction according to one or more aspects.

FIG. 8 is a flow diagram illustrating another example process that supports sidelink assisted beam blockage prediction according to one or more aspects.

FIG. 9 is a flow diagram illustrating yet another example process that supports sidelink assisted beam blockage prediction according to one or more aspects.

FIG. 10 is a block diagram of an example UE that supports sidelink assisted beam blockage prediction according to one or more aspects.

FIG. 11 is a block diagram of an example base station that supports sidelink assisted beam blockage prediction according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

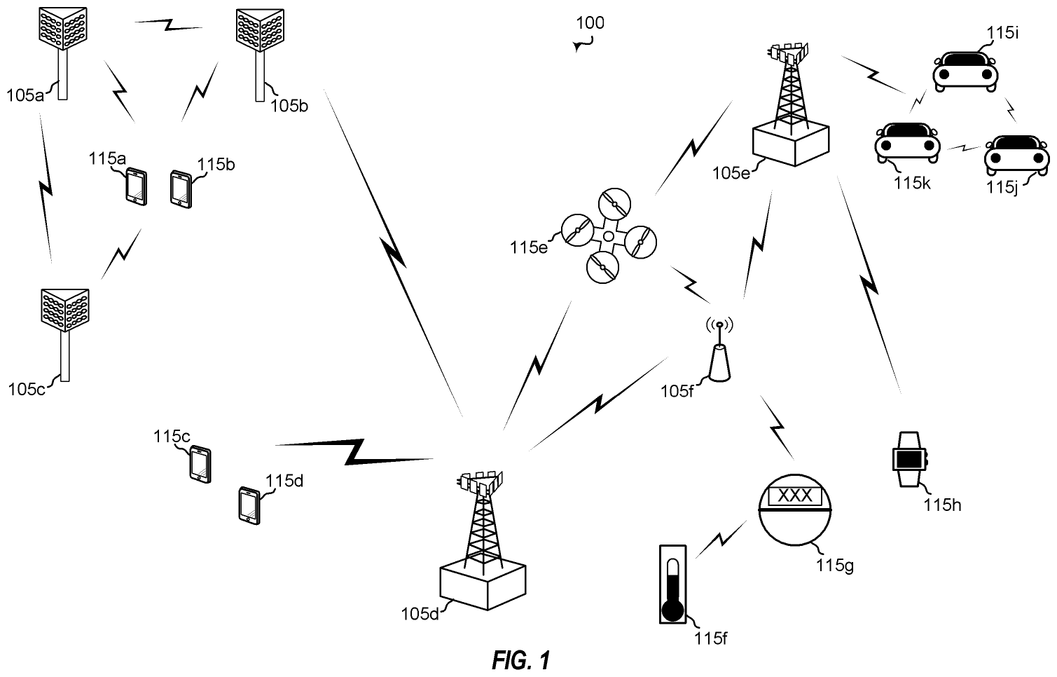

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

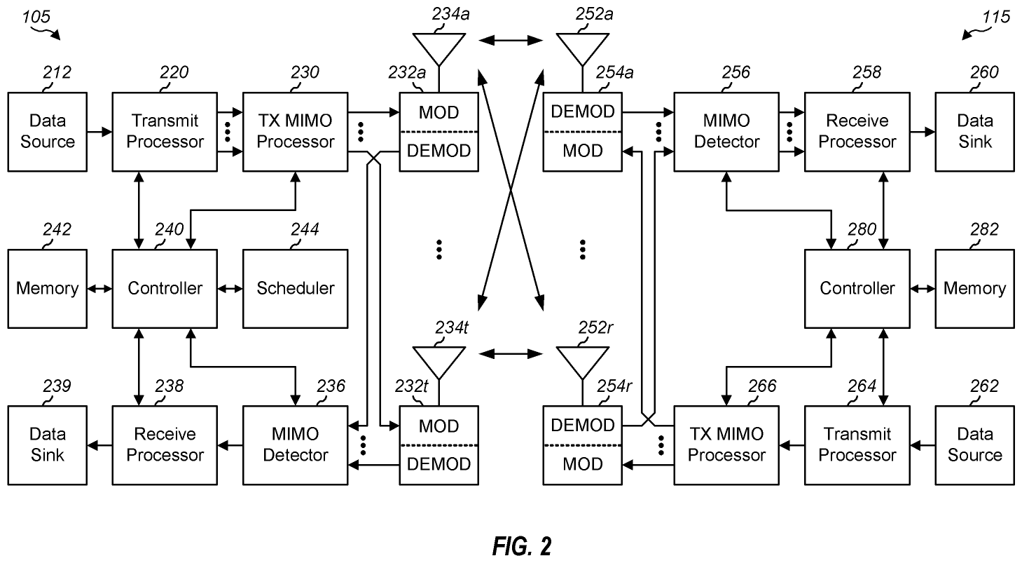

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 1-10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Beam management procedures typically include initial access of using set beams (e.g., SSBs) and procedures (e.g., RACH) to establish operation in a connected mode. Once in a connected mode, there are procedures to continually measure and update beams to ensure good quality. However, there are times when blockages occur, which can lead to more temporary interruptions, like beam failure and recovery, or more longer or severe interruptions like radio link failure.

It has been proposed to use beam prediction in the time and/or spatial domains to better select or refine beams for overhead and latency reductions. Beam prediction may enable improved selection of beams, finer or narrower beams (smaller radiation spread or leakage, and higher direction power) and/or more accurate positioning estimates, which are used in beam selection. More accurate positioning estimates may help when a device is operations with a no line of sight (NLOS) condition.

In the aspects described herein, beam blockage prediction operations and signaling schemes are provided to enable prediction of upcoming future beam blockages on a particular channel and to enable delivery of the beam blockage prediction information via another channel. For example, blockage predictions for communications, such as uplink and/or downlink communications or other communications through a Uu interface (e.g., logical radio or air interface between a UE and base station), may be routed to the network via a sidelink channel transmission and/or an indication from the network to resolve the blockage may be routed to the affected UE via a sidelink channel transmission. To illustrate, a beam blockage instance on a particular channel or for a particular serving cell for uplink and/or downlink may be predicted or estimated to occur at some time in future. A UE may then transmit information regarding this predicted beam blockage, such as in a beam blockage prediction message, to another UE via a sidelink channel. The other UE may not be suffering from the blockage (at least at the same time as the primary UE) or may have advanced or additional capabilities (e.g., higher coverage, battery power, transmit power, and/or computation) to overcome or not be affected by the blockage. Uu communications as referred to herein include communications which occur or are facilitated by the Uu interface. Uu communications may include uplink and/or downlink communications between a UE and a network device. PC5 communications as referred to herein include communications which occur or are facilitated by a PC5 interface (e.g., logical radio or air interface between UEs). PC5 communications may include device-to-device communications through a sidelink channel or channels.

Alternatively, in other aspects the second UE or relay UE may determine the beam blockage prediction based on measurement information received from the first UE. For example, the first UE may have limitations in terms of processing and power and/or may provide the second UE with measurement information via a sidelink channel transmission or transmissions. The second UE may then receive the measurement information and determine a predicted beam blockage for the first UE. Similar to the above aspect, the second UE may communicate with the network to inform the network of the predicted blockage, and to delivery or relay to the first UE via sidelink transmissions and indications from the network to resolve the predicted beam blockage.

Accordingly, beam blockage instances may be resolved more often resulting in reduced beam failures and radio link failures. Accordingly, the entire operation of the network is improved from faster throughout, to reduced latency, increased quality from fewer dropped calls, etc.

As the beam blockage instance may only be determine shortly in time before the predicted blockage is to occur, in many scenarios asking a device to report a beam blockage on a channel with an upcoming blockage is likely to be problematic. For example, the UE may not have the capabilities to overcome the predicted or actual blockage. To illustrate, the UE may be limited in coverage and/or power to handle the blockage. Thus, transmitting the beam blockage on the channel or serving cell will still lead to beam and radio link failure in many cases. This problem may be affect lower capability or less premium UEs more disproportionally. For example, a reduced capability UE (e.g., RedCap UE), an IoT UE, a battery powered UE, previous generation UE, etc. may have power, coverage, interference or other limitations as compared to a current generation, larger, or non-battery powered UE.

In some aspects the beam blockage prediction techniques utilize artificial intelligence (AI) or machine learning (ML). For example, a UE may utilize the beam measurement information in one or more AI or ML processes, such as AI- or ML-assisted predictive beam management operations. Such AI/ML assisted predictive beam management operations may include or correspond to AI/ML based time domain Beam Blockage Prediction or AI/ML based frequency domain Beam Blockage Prediction.

In a particular aspects, the Beam Blockage Prediction may utilize RSRP Fingerprints. RSRP fingerprints (RSRP fingerprint information may include or correspond to a time series of L1-RSRPs associated with spatially swept beams. These RSRP fingerprints can be used to train AI- or ML-models to predict beam blockage related quantities, including blockage event, instance, severity, and direction. Additionally, the network may enable further training of these AI-or ML-models. For example, the data can be labeled with actual beam failure instances together with the ID of the failed beam.

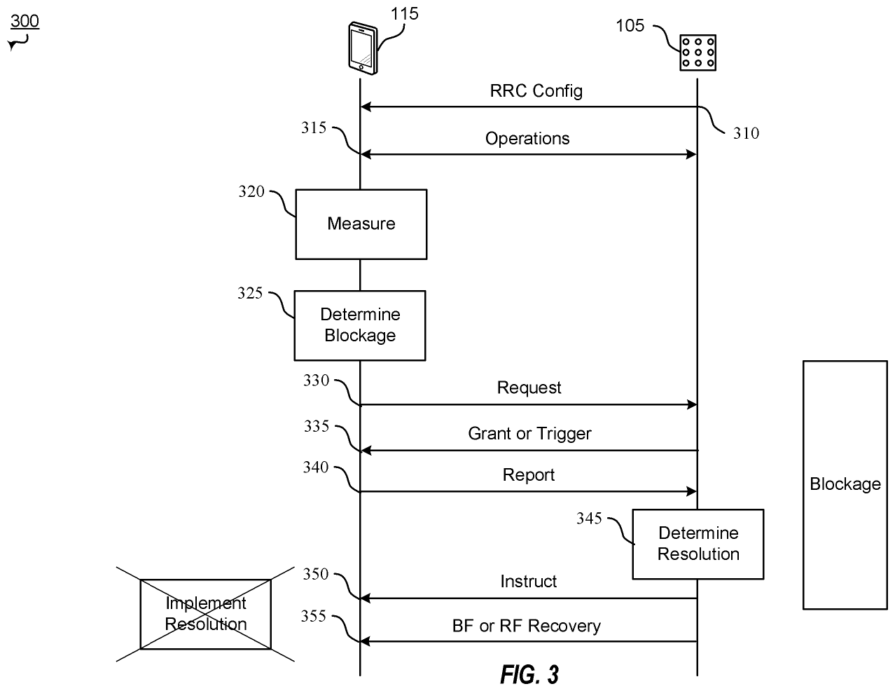

FIG. 3 is a timing diagram illustrating an example of a wireless communication system experiencing beam blockage according to one or more aspects. In the example of FIG. 3, a diagram 300 of a network using beam blockage prediction procedures is depicted. The network may include a base station 105 and a UE 115.

The base station 105 and the UE 115 may perform initial access operations for the UE 115 to connect to the base station 105 and the network. As part of the access operations or after access is established, the base station 105 may configure the UE 115 for operations in the network. For example, at 310, the base station 105 transmits a RRC configuration message including beam monitoring configuration information. The beam monitoring configuration information may include beam blockage prediction configuration information to enable the UE 115 to begin beam blockage prediction measurements.

At 315, the UE 115 performs one or more operations according to the RRC configuration and initial access operations. For example, the UE 115 may transmit or receive communications with the base station 105, report channel conditions, etc.

As part of the one or more operations, at 320, the UE 115 performs one or more measurements on one or more channels between the UE 115 and the base station 105. For example, the UE 115 may determine layer 1 measurement information, such as reference signal received power (RSRP), based on one or more reference signals from the base station 105 for the one or more channels.

At 325, the UE 115 determines a beam blockage prediction based on the measurements. For example, the UE 115 may predict or estimate a future/upcoming beam blockage instance based on measurement information generated from the measurements.

While performing the operations, the UE 115 may experience fluctuations in signal quality or a decrease in signal quality indicating channel conditions are deteriorating and a potential blockage is or will occur. The blockage may be caused by a change at the UE (e.g., movement or rotation) or a change in the channel (e.g., blockage by another object or interference from another device). This decrease in signal quality could lead to beam failure or even radio link failure. As a determination or permission to use a new beam may be determined by the network and signaled through a RRC message, the network may not be able to dynamically adjust parameters of the operations, such as for or during resources configured by the RRC configuration message.

Accordingly, the UE 115 may need to request additional or distinct resources to report the predicted beam blockage. For example, at 330, the UE 115 requests resources to report the predicted beam blockage. At 335, the base station 105 may transmit a grant or trigger message for sending information regarding the predicted beam blockage response to the request message.

At 340, the UE 115 reports the predicted beam blockage based on the grant or trigger message. For example, the UE 115 uses the transmission resources indicated in the grant or trigger message to report the predicted beam blockage. At 345, the base station 105 determines an action to resolve the predicted beam blockage. For example, the base station 105 may change a transmission parameter of the UE 115.

At 350, the base station 105 may transmit an indication or instruction to the UE 115 to resolve the predicted beam blockage, and at 355 a beam failure or radio link failure may occur because the UE 115 was unable to receive and/or implement the instruction prior to the predicted blockage occurring between the UE 115 and the base station 105.

For example, after the determination of the predicted beam blockage at 325, a blockage may occur between the UE 115 and the base station 105. For example, a blockage may occur from 330 to 350 on a channel between the UE 115 and the base station 105. The blockage may reduce transmission functionality and/or prohibit transmissions outright during this time. One or more operations from 330 to 350 may not occur. Accordingly, the UE 115 may not be able to implement a resolution for the predicted beam blockage event even though it was able to predict the beam blockage prior to the event. I

Accordingly, in the example of FIG. 3 the network is not able to resolve a predicted beam blockage instance and instead utilizes beam failure or radio link recovery processes. One problem with such a configuration is that beam blockage report is being performed on the very channel and/or serving cell where the blockage is predicted to occur. Additionally, beam blockage prediction may utilize additional processing power and battery power that certain types of devices may not be capable of.

In the aspects described herein, a network may utilize sidelink assisted beam blockage prediction schemes which enable reduce capability devices or devices with low resources to participate in beam blockage prediction operations. Additionally, the sidelink assisted (e.g., sidelink relay) aspects described herein enable a device to report a predicted beam blockage via a different channel or cell (e.g., by use of different, relay device) which is less likely to experience the blockage. Accordingly, the predicted blockages can be detected more close in time to the occurrence and still be fixable/resolvable. This closer in time prediction may enable reduced processing and power consumption from less intensive/less forward looking calculations, and the closer in time prediction increases accuracy when detecting of predicted beam blockage and an accuracy of the parameters of the predicted blockage. Thus, the aspects described herein may reduce latency and increase throughput by improving beam blockage prediction and reducing beam and/or link failure, which results in a more efficient network.

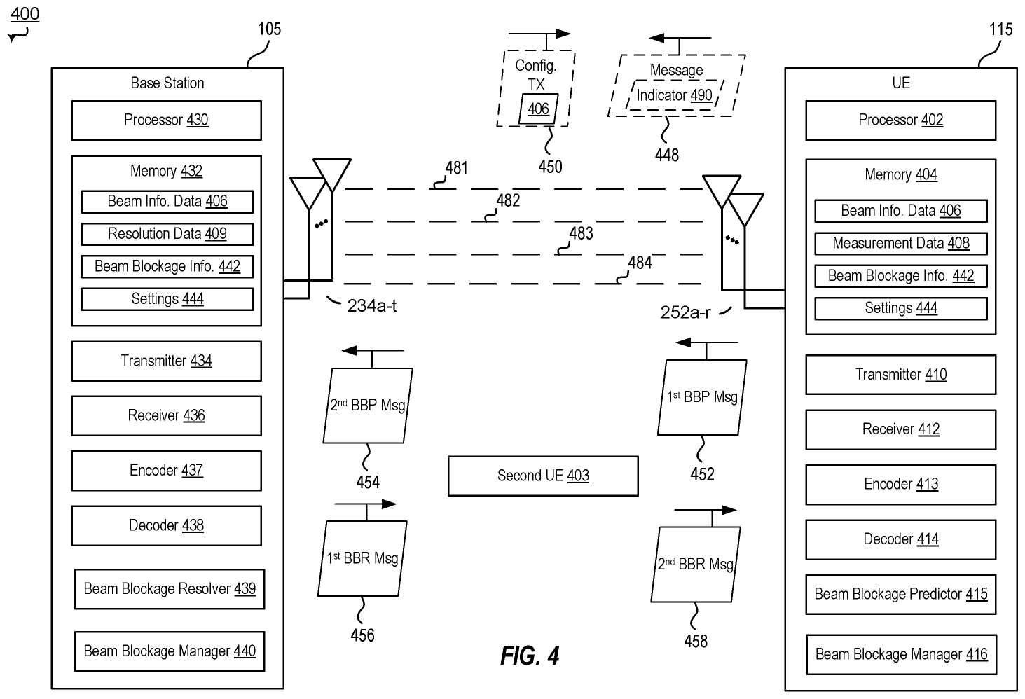

FIG. 4 illustrates an example of a wireless communications system 400 that supports sidelink assisted beam blockage prediction in accordance with aspects of the present disclosure. In some examples, wireless communications system 400 may implement aspects of wireless communication system 100. For example, wireless communications system 400 may include a network, such as one or more network entities, and one or more UEs, such as UE 115 (also referred to as a first UE) and second UE 403. As illustrated in the example of FIG. 4, the network entity includes a corresponds to a base station, such as base station 105. Alternatively, the network entity may include or correspond to a different network device (e.g., not a base station). Sidelink assisted beam blockage prediction operations may reduce beam or radio link failure, and thus reduce latency and increase throughput. Accordingly, network and device performance can be increased.

Base station 105, UE 115, and second UE 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via base station 105, UE 115, and second UE 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, beam blockage predictor 415, beam blockage manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store beam information data 406, measurement data 408, beam blockage information 442, settings data 444, or a combination thereof, as further described herein.

The beam information data 406 includes or corresponds to data associated with or corresponding to beam information for transmitting and receiving communications. For example, the beam information data 406 may include beam shape information, TCI state information, or a combination thereof. The beam shape information may include beam pointing direction or angle, beam width, beam weights or coefficients, reference signal information, or a combination thereof. The beam information data 406 includes data for a current/active beam, configured/allowable beams, and optionally for one or one or more default beams, such as one or more default beams to be used for beam blockages. Additionally, or alternatively, the beam information data 406 may include data from the network (e.g., base station 105) which indicates a new beam to use or parameters thereof. The beam information data 406 may be configured by RRC and/or modified by MAC-CE and/or DCI.

The measurement data 408 includes or corresponds to data associated with or corresponding to channel measurements and quality determinations, such as or similar to measurements used for CSI reporting. For example, the measurement data 408 may be generated based on measurements of reference signals and correspond to physical layer, layer 1, measurements such as physical layer power and/or quality measurements and/or metrics. Exemplary physical layer power and/or quality measurements and/or metrics include RSRP, RSRQ, SINR, etc., as illustrative, non-limiting examples. In some implementations, the measurement data 408 further includes information derived from physical layer measurements, such as variance of one or more of the measurements over time or space. For example, the measurement data 408 may include time and/or spatial L1-RSRP variance associated with a number of downlink reference signals.

The beam blockage information 442 includes or corresponds to data indicating or corresponding to a predicted beam blockage instance. For example, the beam blockage information 442 may include predicted beam blockage data indicating information about the predicted beam blockage (beam blockage instance information) which may include one or more of starting time information, duration information, severity information, or blockage direction information. Additionally, or alternatively, the beam blockage information 442 includes identifier information for the affected devices (e.g., the first UE 115), serving cell identifier information (e.g., where the blockage occurs or affects with regards to the network.

The settings data 444 includes or corresponds to data associated with sidelink assisted beam blockage prediction operations. The settings data 444 may include one or more types of sidelink assisted beam blockage prediction operation modes and/or thresholds or conditions for switching between sidelink assisted beam blockage prediction modes and/or configurations thereof. For example, the settings data 444 may have data indicating different thresholds and/or conditions for different sidelink assisted beam blockage prediction modes, such as a prediction mode, a measurement only mode, a relay mode, etc., or a combination thereof. As another example, the settings data 444 may include thresholds and/or conditions for determining a predicted blockage, determining when to send measurement data, determining when to send a predicted blockage, etc. In some implementations, the settings data 444 may include one or more pathloss conditions for determining when to send a predicted beam blockage message.

In a particular implementation, the pathloss conditions may be determined and/or adjusted based on message or channel bandwidth. To illustrate, for a large payload size message, the pathloss condition may be small (and vice versa). One benefit for this is that such blockage prediction messages would be used to preserve link quality and delivering these messages with lower latency and high reliability would preserve the link and quality.

Additionally, or alternatively, the settings data 444 may include UE capabilities information, such as transmit power information, battery power information, prediction capability information, relay capability information, etc. The UE capabilities information may be transmitted to another UE and/or network device to enable configuration of sidelink assisted beam blockage prediction operation or selection of a particular sidelink assisted beam blockage prediction operation mode.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Beam blockage predictor 415 may be configured to perform beam blockage prediction to determine a beam blockage prediction instance. For example, beam blockage predictor 415 may be configured to determine an upcoming or future instance of beam blockage for uplink downlink communications based on measurement information, such as the measurement data 408. To illustrate, the beam blockage predictor 415 may determine an RSRP fingerprint based on physical layer measurements and compare the determined RSRP fingerprint to stored RSRP fingerprints which have been generated, curated, or filtered by AI or ML methods. As another illustration, the beam blockage predictor 415 may determine that a variance in a particular physical layer measurement/metric has a variance that exceeds a threshold or that particular physical layer measurement/metric is deteriorating at a rate that exceeds a threshold.

Additionally, or alternatively, the beam blockage predictor 415 may be configured to determine a duration, severity, and/or location of the predicted beam blockage instance. For example, the beam blockage predictor 415 may utilize measurement information and/or AI/ML methods to predict when the blockage will start, how long it will last, a severity of the blockage (e.g., partial, total, resolvable, unresolvable, etc.), and what channels and/or devices the blockage will affect. The “location” of the blockage may be indicated by direction, beam, channel, serving cell, device ID, or a combination thereof.

Beam blockage manager 416 may be configured to perform sidelink assisted beam blockage prediction operations, such as sidelink signaling operations for beam blockage prediction messages. For example, beam blockage manager 416 is configured to determine when to measure, what to measure, when to report, what to report, who to report to, etc. Additionally, beam blockage manager 416 may be configured to determine when to transmit a beam blockage prediction message. To illustrate, beam blockage predictor 415 may compare uplink pathloss determinations to a threshold to determine whether to transmit a predicted beam blockage instance which was determined by the beam blockage predictor 415. As another example, beam blockage manager 416 may be configured to perform or coordinate measurement operations, such as physical layer measurement operations, on downlink reference signals to generate the measurement data 408. In some implementations, the beam blockage manager 416 may be configured to determine a potential resolution for the predicted beam blockage instance, which may be indicated to the network, such as to the base station 105 via another UE by sidelink channel transmission to the other UE.

Second UE 403 may include one or more elements similar to UE 115. In some implementations, the UE 115 and the second UE 403 are different types of UEs. For example, either UE may be a higher quality or have different operating constraints. To illustrate, one of the UEs may have a larger form factor or be a current generation device, and thus have more advanced capabilities and/or reduced battery constraints or higher processing constraints. In some implementations, one UE may be battery powered and another UE may be charging (e.g., plugged into an outlet, a car recharged by an alternator, etc.). One device may be an IoT device and another device may be a reduced capability device (RedCap). In other implementations, the two UEs have similar capabilities. UE 115 and second UE 403 may be configured to communicate over one or more sidelink channels.

Base station 105 includes processor 430, memory 432, transmitter 434, receiver 436, encoder 437, decoder 438, beam blockage resolver 439, beam blockage manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store beam information data 406, resolution data 409, beam blockage information 442, settings data 444, or a combination thereof, similar to the UE 115 and as further described herein.

Resolution data 409 may include or correspond to data associated with resolving a predicted beam blockage instance. For example, the resolution data 409 may indicate or identify one or more operations for resolving the beam blockage instance. To illustrate, the resolution data 409 may indicate a beam change (e.g., adjusted or default TCI state), a change in periodicity (e.g., decreased period to avoid or increased period to refine or updated the blockage), or a reference signal change (e.g., to use different or default BFD-RSs), as illustrative, non-limiting examples.

Additionally, the resolution data 409 may include information for generating or determining a resolution based on a beam blockage prediction information. For example, the resolution data 409 may include one or more conditions or thresholds for determining operations to reduce or avoid a predicted beam blockage instance.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of UE 115 described with reference to FIG. 2.

Encoder 437, and decoder 438 may include the same functionality as described with reference to encoder 413 and decoder 414, respectively. Beam blockage resolver 439 may include similar functionality as described with reference to beam blockage predictor 415. For example, the beam blockage resolver 439 may be configured to analyze the predicted beam blockage instance to determine a fix or solution for resolving the beam blockage instance without beam or radio link failure. Beam blockage manager 440 may include similar functionality as described with reference to beam blockage 416.

During operation of wireless communications system 400, the network (e.g., base station 105) may determine that UE 115 has sidelink assisted beam blockage prediction capability. For example, UE 115 may transmit a message 448 that includes a sidelink assisted beam blockage prediction indicator 490 (e.g., a sidelink assisted beam blockage prediction capability indicator). Indicator 490 may indicate sidelink assisted beam blockage prediction capability for one or more communication modes, such as downlink, uplink, etc. In some implementations, a network entity (e.g., a base station 105) sends control information to indicate to UE 115 that sidelink assisted beam blockage prediction operation and/or a particular type of sidelink assisted beam blockage prediction operation is to be used. For example, in some implementations, configuration transmission 450 is transmitted to the UE 115. The configuration transmission 450 may include or indicate to use sidelink assisted beam blockage prediction operations or to adjust or implement a setting of a particular type of sidelink assisted beam blockage prediction operation. For example, the configuration transmission 450 may include beam information data 406, as indicated in the example of FIG. 4, beam blockage information 442, settings data 444 or any combination thereof.

During operation, devices of wireless communications system 400, perform sidelink assisted beam blockage prediction operations. For example, the network and UE 115 may exchange transmissions via uplink and/or downlink communications, such as via a downlink channel as illustrated in the example of FIG. 4. The UE 115 may perform one or more measurement operations on the uplink and/or downlink communications to generate measurement information, such as the measurement data 408. For example, the UE 115 may perform physical layer measurements on received downlink reference signals of downlink communications to determine power and/or quality parameters, such as RSRP. The UE 115, such as beam blockage predictor 415 thereof, may analyze the measurement information to determine if there will be an upcoming beam blockage between the UE 115 and the base station 115. In some implementations, the UE 115 may process the measurement information to generate additional information, such as measurement/metric variance or RSRP fingerprints, and compare the variance or RSRP fingerprint to stored conditions or fingerprints to predict if there will be a beam blockage. After determining that there will be a beam blockage, the UE 115 transmits an indication of the predicted beam blockage to the network indirectly via sidelink assisted operations, such as sidelink relay operations.

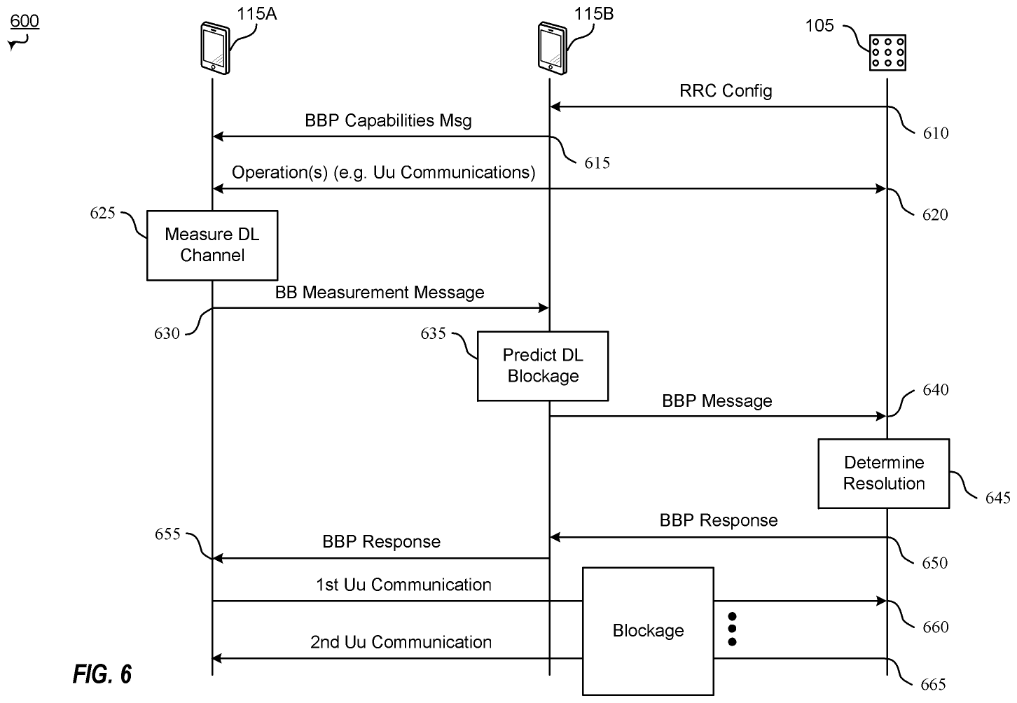

In the example of FIG. 4, the UE 115 transmits a first beam blockage prediction message 452 to the second UE 403 via a sidelink channel. The first beam blockage prediction message 452 may include or correspond to SCI, a SL-MAC-CE, or a SL-RRC message. For example, the first beam blockage prediction message 452 may include or correspond to a PSSCH transmission which is scheduled by a PSCCH transmission, such as the SCL-MAC-CE scheduled by the SCI. In some implementations, the first beam blockage prediction message 452 includes a beam blockage prediction indicator which indicates an upcoming beam blockage. In other implementations, the first beam blockage prediction message 452 include beam blockage prediction information which identifies one or more parameters or characteristics of the predicted beam blockage instance, such as start time, duration, severity, etc. Alternatively, the first beam blockage prediction message 452 may not include an indication of a predicted beam blockage instance, but instead include measurement information, such as described further with reference to FIG. 6. In such implementations, the second UE 115 receives the measurement information of and from the UE 115, and the second UE 115 performs beam blockage prediction on the measurement information from and for the UE 115. The second UE 115 then transmits the beam blockage prediction it generated to the network, such as the base station 105.

The second UE 115 may receive the first beam blockage prediction message 452 and transmit a second beam blockage prediction message 454 to the network via an uplink channel based on the first beam blockage prediction message 452. The second UE 403 may perform one or more operations on the first beam blockage prediction message 452 to generate and transmit the second beam blockage prediction message 454. For example, the second UE 403 may decode and generate a new message which includes a portion (e.g., the predicted beam blockage instance indicator or information) of the first beam blockage prediction message 452. As another example, the second UE 403 may amplify the second beam blockage prediction message 454 and forward the first beam blockage prediction message 452 via an uplink channel as the second beam blockage prediction message 454. The second beam blockage prediction message 454 may include or correspond to a PUCCH, PUSCH, or MAC-CE transmission. In some implementations, the second beam blockage prediction message 454 includes information for multiple predicted beam blockage instances, such as one or more instances for the UE 115 and/or one or more instances for at least one other UE (e.g., a third UE).

The base station 105 receives the second beam blockage prediction message 454 from the second UE 403 and processes the second beam blockage prediction message 454 to obtain an indication of the predicted beam blockage instance from (or for) the first UE 115. The base station 105 analyzes the predicted beam blockage instance to determine a resolution for the predicted beam blockage. For example, the base station 105 may determine that the blockage is directional in nature and can be overcome by changing beams. The base station 105 may determine that a particular beam, such as a default beam (e.g., default TCI state) or other configured beam at the first UE 115, can be used to avoid message failure and beam or radio link failure.

The base station 105 transmits a first beam blockage response message 456 including an indication for resolving the predicted beam blockage instance to the second UE 403 via a downlink transmission. The first beam blockage response message 456 may include or correspond to a PDCCH transmission, such as DCI, a PDSCH transmission, or a MAC-CE transmission. As described above, the indication may include a particular action for the first UE 115 to implement to overcome or avoid the predicted beam blockage.

The second UE 115 may receive the first beam blockage response message 456 from the base station 105, and transmit a second beam blockage response message 458 to the base station 115 via a sidelink channel based on the first beam blockage response message 456. The second UE 403 may perform one or more operations on the first beam blockage response message 456 to generate and transmit the second beam blockage response message 458. For example, the second UE 403 may decode and generate a new message which includes a portion (e.g., the resolution indication or information) of the first beam blockage response message 456. As another example, the second UE 403 may amplify the first beam blockage response message 456 and forward the first beam blockage response message 456 via a sidelink channel as the second beam blockage response message 458. The second beam blockage response message 458 may include or correspond to a SCI, PSCCH, PSSCH, SL-MAC-CE transmission, or SL-RRC transmission. In some implementations, the first beam blockage response message 456 includes resolution indications or information for multiple reported predicted beam blockage instances, such as one or more instances for the UE 115 and/or one or more instances for at least one other UE (e.g., the second UE 403, a third UE, etc.). In such implementations, the second UE 403 may transmit additional beam blockage response messages to the other UEs. For example, the multiple indications may be transmitted via a group common DCI (GC-DCI), or a GC-DCI scheduled PDSCH, and a RNTI and/or fields within the GC-DCI can be associated with identifiers for the different UEs. To illustrate, the GC-DCI may include multiple fields associated with different UEs, and the second UE 403 may determine one or more fields associated with the multiple UEs. In a particular implementation, the second UE may transmit a group transmission to a sidelink group indicating the information for resolving the multiple blockages.

The UE 115 receives the second beam blockage response message 458 and may perform one or more operations based on the resolution indicator or information therein. For example, the UE 115 may transmit or receive a transmission using adjusted beam information, such as an adjusted or default TCI. As another example, the UE 115 may perform one or more measurements using adjusted reference signal information. Additionally, or alternatively, the UE 115 adjusts a periodicity of one or more periodic or semi-periodic transmissions. To illustrate, the UE 115 may adjust a periodicity to avoid the blockage or to increase a periodicity of beam blockage prediction messages (including measurements or predicted beam blockages) to enable the network to receive additional information regarding the predicted beam blockage instance.

Accordingly, the network (e.g., the base station 105, the UE 115, and the second UE 403) may be able to more efficiently and more reliably provide predicted beam blockages to a network. Sidelink assisted beam blockage prediction may reduce beam failure and radio link failure and reduce or prevent the use of recovery operations due to beam or link failure. Additionally, sidelink assisted beam blockage prediction may enable reduced capability devices, such as reduced with respect to physical capability and/or due to channel conditions, to operate in a predicted beam blockage mode. Accordingly, the network will experience reduced errors and latency, and increased throughput.

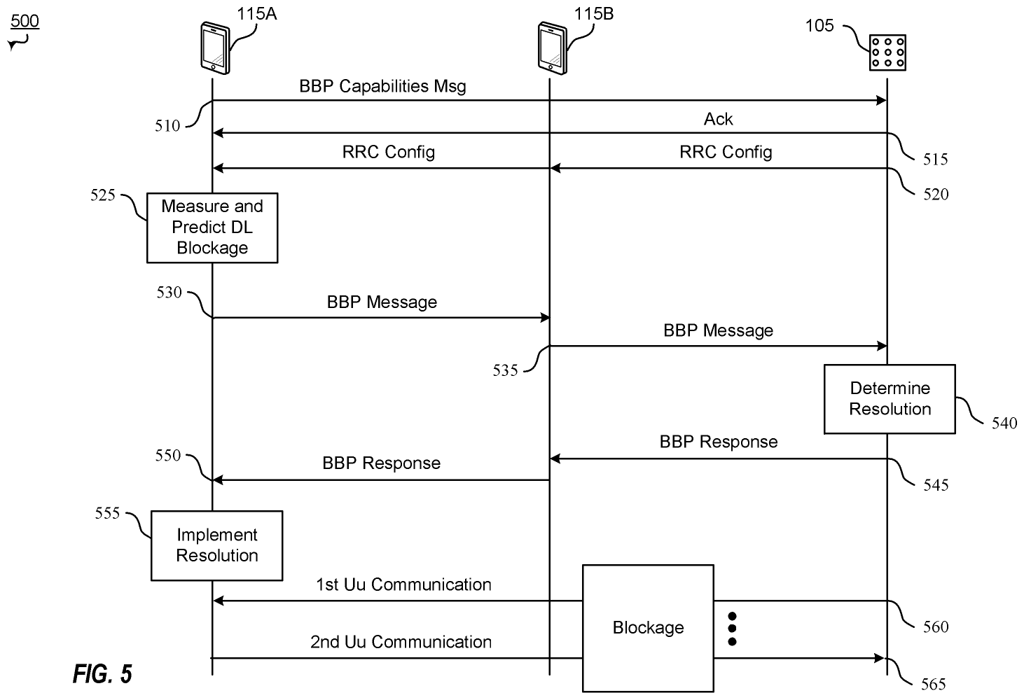

Referring to FIG. 5, FIG. 5 is a timing diagram 500 illustrating a wireless communication system that supports sidelink assisted beam blockage prediction according to one or more aspects. The example of FIG. 5 corresponds to an example of sidelink assisted beam blockage prediction where a blocked UE performs beam blockage prediction.

The example of FIG. 5 includes similar devices to the devices described in FIGS. 1, 2, and 4, such as a first UE 115A, a second UE 115B, and a network entity 505. The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate joint transmissions and receive the joint transmissions. In some implementations, network entity 505 may include or correspond to multiple TRPs of a single base station (e.g., base station 105), to multiple base stations, or any combination thereof.

At 510, the first UE 115A transmits a beam blockage capabilities message to the base station 105. For example, the first UE 115A may transmit an uplink transmission including beam blockage capability information. As described with reference to FIG. 4, the beam blockage capability information may indicate a beam blockage measurement capability, a beam blockage prediction capability, a beam blockage indication or message relay capability, a transmit power capability (e.g., power headroom), a coverage capability, a power capability (e.g., battery capacity or level), or a combination thereof. The uplink transmission may include or correspond to a RRC message, a MAC-CE, UCI, a PDCCH, or a PUSCH.

At 515, the base station 105 may transmit an acknowledgement message responsive to the beam blockage capabilities message. For example, the base station 105 may transmit an acknowledgement message indicating receipt of the beam blockage capabilities message and which includes an indication of a particular beam blockage prediction mode, and/or beam blockage prediction configuration information. The first UE 115A may receive the acknowledgement message and begin to perform beam blockage prediction operations.

At 520, the base station 105 optionally transmits a beam blockage prediction configuration message. The beam blockage prediction configuration message includes beam blockage prediction configuration information. The beam blockage prediction configuration message may be sent when the acknowledgement message does not include beam blockage prediction configuration information. Additionally, or alternatively, a beam blockage prediction configuration message may be sent to at least one UE when the UEs do not communicate with each other to configure beam blockage prediction operations or relay configuration information to each other that is received from the base station 105. To illustrate, when the first UE 115A does not coordinate configuration of the second UE 115B for beam blockage prediction operations, the base station 105 may transmit the configuration information to the second UE 115B to configured the second UE 115B.

For example, in some implementations the base station 105 may transmit a RRC message including the beam blockage prediction configuration information to the second UE 115B only. In other implementations, the base station 105 may transmit a RRC message including the beam blockage prediction configuration information to the first UE 115A only. In yet other implementations, the base station 105 may transmit a RRC message including the beam blockage prediction configuration information to both of the first UE 115A and the second UE 115B.

After beam blockage prediction configuration, the first UE 115A, the second UE 115B, and the base station 105 may engage in one or more operations. For example, the base station 105 may perform one or more downlink related operations for the first UE 115A and/or the second UE 115B. As another example, the first and second UEs 115A and 115B may perform sidelink operations. In some implementations, the first UE 115A and the second UE 115B may transmit an additional configuration message or messages to adjust beam blockage prediction operations, such as to engage in or adjust periodic (e.g., semi-persistent) transmission of beam blockage messages. As indicated above, in the example of FIG. 5, the first UE 115A is configured to determine predicted beam blockages for itself. In alternative implementations, the first UE 115A may configure the second UE 115B for beam blockage prediction operations on its behalf, such as to determine beam blockage predictions for the first UE 115A based on measurement information from the first UE 115A, as further described with reference to FIG. 6.

In the example of FIG. 5, the first UE 115A may be capable of predicting beam blockages and may be configured by the base station 105 to perform beam blockage prediction using the second UE 115B as a relay or forwarding UE to avoid potential blockage issues between the first UE 115A and the base station 105 when reporting the predicted beam blockage.

At 525, the first UE 115A may determine a predicted beam blockage instance. For example, the first UE 115A may perform one or more measurement operations on one or more downlink transmissions, such as reference signals thereof, during the first UE's 115A operations with the base station 105 to generate measurement information. The measurement information may include or correspond to the measurement information described with reference to FIG. 4, such as measurement data 408. To illustrate, the measurement information may include layer one, physical layer, measurements of RSRP and other quantities generated from the downlink or uplink operations performed after beam blockage prediction configuration.

After generation of the measurement information, the first UE 115A may determine a predicted beam blockage instance based on the measurement information. For example, the first UE 115A may determine a predicted beam blockage instance based on the measurement information itself, such as raw layer 1 measurements/metrics, or based on information derived from the measurement information, such as time and/or spatial variances of particular quantities of the measurement information and associated with a number of downlink reference signals. This derived information may alternatively include or correspond to RSRP fingerprint information and may be matched with stored model RSRP fingerprint data to predict an upcoming blockage.

To illustrate, the first UE 115A determines the predicted beam blockage instance based on AI or ML operations or AI or ML model data. As an illustrative example, the first UE 115A may generate an RSRP fingerprint based on the measurement information and compare the RSRP fingerprint to stored RSRP fingerprints which are associated with past beam blockages for the first UE 115A, other UEs, or both. Based on the comparison indicating a match, indicating a match within threshold level (e.g., high correlation), or finding a quantity of similar markers above of threshold, the first UE 115A may predict a beam blockage instance. In some implementations, the first UE 115A further determines details of the predicted beam blockage instance based on the measurement information or the AI/ML information.

At 530, the first UE 115A transmits a beam blockage prediction message including an indication of the predicted beam blockage instance via a sidelink channel. The beam blockage prediction message may be sent via a first type of communications interface (e.g., a Uu interface or a PC5 interface) and may include or correspond to a SCI, a SCI-MAC-CE, or a SL-RRC message. For example, the first UE 115A may transmit a beam blockage prediction message including beam blockage prediction indicator which is configured to indicate that a predicted beam blockage instance has been detected. To illustrate, this indicator may include or correspond to a single bit which indicates a predicted blockage has been identified. As another example, the first UE 115A may transmit a beam blockage prediction message including beam blockage prediction information which indicates or identifies information about the predicted beam blockage instance. To illustrate, the beam blockage prediction information may include the information (e.g., beam blockage information 442) described with reference to FIG. 4, such as beam blockage instance information, identifier information for the first UE 115A, serving cell identifier information, or a combination thereof. The beam blockage instance information may include starting time information, duration information, severity information, blockage direction information, or a combination thereof.

Additionally, or alternatively, the beam blockage prediction message includes beam blockage measurement information. The beam blockage measurement information may include reference signal received power (RSRP) measurement information or parameters derived from the RSRP measurement information and an example of operations for the beam blockage prediction message including beam blockage measurement information are described further with reference to FIG. 6.

In some implementations, the beam blockage prediction message is an aperiodic communication. For example, the beam blockage prediction message may be scheduled or triggered by a prior sidelink transmission (for UE scheduled sidelink, such as a SCI or PSCCH) or downlink transmission (for network scheduled sidelink, such as a DCI or PDCCH). In other implementations, the beam blockage prediction message is periodic, such as persistent, semi-persistent, etc. In such implementations, no scheduling (e.g., trigger) message on the channel may be used which precedes the beam blockage prediction message, however, a prior configuration or grant message (e.g., activation message or higher layer message) can be used to allocate multiple transmission resources to the first UE 115A for the transmission of multiple beam blockage prediction messages.

At 535, the second UE 115B receives the beam blockage prediction message from the first UE 115A and transmits a second beam blockage prediction message to the base station 105 via an uplink channel. For example, the second UE 115B receives the beam blockage prediction message and transmits (forwards or relays) the beam blockage prediction message to the base station 105 via PUCCH or PUSCH. As another example, the second UE 115B receives the beam blockage prediction message and decodes (at least partially) the beam blockage prediction message. The second UE 115B may generate a second beam blockage prediction message based on the decoded beam blockage prediction message, such as a portion thereof. The second UE 115B then transmits the second beam blockage prediction message, which is different than the beam blockage prediction message, to the base station 105 via PUCCH or PUSCH. The second beam blockage prediction message may include or correspond to an amplified beam blockage prediction message, a modified beam blockage prediction message, or a combination thereof. For example, the second beam blockage prediction message may include beam blockage predictions from multiple other UEs, such as the first UE 115A and a third UE (not shown). When relaying/forwarding the message, the second UE 115B may decode-and-forward (DF) or amplify-and-forward (AF). In a DF relay, a UE decodes, re-modulates and retransmits the received signal, while in a an AF relay, the UE simply amplifies and retransmits the signal without decoding. Accordingly, in some implementations, such as for AF relay, the second UE 115B may transmit the same or almost the same message it received. The second UE 115B may transmit the second beam blockage prediction message via a second type of communications interface (e.g., Uu interface) that is different from the first type of communication interface (e.g., PC5 interface) used to receive the first beam blockage prediction message.

In some implementations, the second beam blockage prediction message is an aperiodic communication. For example, the second beam blockage prediction message may be scheduled or triggered by a prior downlink transmission from the network, such as an uplink grant DCI. In other implementations, the second beam blockage prediction message is periodic, such as persistent, semi-persistent, etc. In such implementations, no scheduling (e.g., trigger) message may be used which precedes the second beam blockage prediction message, however, a prior configuration or grant message (e.g., activation message) can be used to allocate multiple transmission resources to the second UE 115B for the transmission of multiple beam blockage prediction messages to the network (e.g., base station 105).

At 540, the base station 105 receives the beam blockage prediction for the first UE 115A from the second UE 115B, and the base station 105 determines a resolution for the predicted beam blockage instance for the first UE 115A. The resolution may include to use another beam (such as switch TCI states), use different reference signals (such as to use new BFD-RS identifiers), adjust a periodicity of periodic transmissions (such as to increase periodicity of beam blockage prediction messages), delay a transmission, cancel a transmission resource, engage in sidelink delivery of a transmission, transmit to another serving cell, transmit on another frequency, or a combination thereof.

For example, with regards to beam adjustment, the base station 105 may determine to use another beam based on the beam blockage prediction indicator or information. To illustrate, the base station 105 may receive an indication of a predicted blockage without additional information and may determine to use a default beam (default TCI state) based on a generic or non-specific blockage indication. As another illustration, the base station 105 may receive detailed information regarding the blockage and may determine one or more alternative beams to use for or with the first UE 115A that have a lower chance of being affected by the blockage and/or that have a higher chance at overcoming the blockage. In a particular implementation, the base station 105 determines the new beam based on AI or ML and prior to beam failure or radio link failure.

With regards to different reference signals, the base station 105 may determine that the particular blockage may be resolved by adjusting reference signals. Adjusting reference signal may enable different measurements to be obtained and/or different transmit configurations to be used.

With regards to different periodicity, the base station 105 may increase a periodicity of beam blockage prediction message to obtain additional information about the blockage or future potential blockages which may be predicted. Alternatively, the base station 105 may decrease a periodicity of beam blockage prediction message to shift a particular upcoming scheduled beam blockage prediction message so that it no longer coincides with the predicted blockage. Additionally, the base station 105 may adjust, such as decrease, a periodicity of other periodic messages to shift a particular upcoming scheduled periodic message so that it no longer occurs during the predicted blockage.

With regards to other options, the base station 105 may determine the blockage on the channel cannot be resolved by adjustments during the predicted blockage, and the base station 105 may seek alternative resolutions, such as alternative channels for transmission of the data to the network, to avoid the blockage.

At 545, the base station 105 transmits a beam blockage response message to the second UE 115B including an indication for resolution of the predicted beam blockage instance for the first UE 115A. For example, the base station 105 may transmit an indication for the first UE 115A to the second UE 115B for relaying or delivering to the first UE 115A. The indication may indicate or identify the determined resolution from 540 and as described with reference to FIG. 4. The beam blockage response message may be sent via the same type of communications interface (e.g., a Uu interface) used to receive the second beam blockage prediction message and may include or correspond to a downlink channel transmission, such as DCI, MAC-CE, PDCCH, PDSCH, etc.

In some implementations, the beam blockage response message corresponds to a group of UEs and includes a first indication for the first UE 115A and a second indication for another UE, such as the second UE 115B or a third UE (not shown). In some such implementations, each indication may correspond to a predicted beam blockage instance for a particular UE and indications for multiple UEs may be included, along with a corresponding identifier, in the beam blockage response message. Thus, the second UE 115B may decode the beam blockage response message and determine which indications should be sent (e.g., forwarded or relayed) where.

At 550, the second UE 115B receives the beam blockage response message from the base station 105 via a downlink channel and transmits a second beam blockage response message to the first UE 115A via a sidelink channel. For example, the second UE 115B receives the beam blockage response message and transmits (forwards or relays) the beam blockage response message to the first UE 115A via PSCCH or PSSCH. The beam blockage response message may be received via the first type of communications interface (e.g., Uu interface) and the second beam blockage response message be sent via either communications interface (e.g., a Uu interface or a PC5 interface) and optionally via the first type of communications interface used to send the beam blockage measurement message. As another example, the second UE 115B receives the beam blockage response message and decodes (at least partially) the beam blockage response message. The second UE 115B may generate a second beam blockage response message based on the decoded beam blockage response message. The second UE 115B then transmits the second beam blockage response message, which is different than the beam blockage prediction message, to the base station 105 via PUCCH or PUSCH. The second beam blockage response message may include or correspond to an amplified beam blockage response message, a modified beam blockage response message, or a combination thereof. For example, the second beam blockage response message may include beam blockage responses for multiple other UEs, such as the first UE 115A and the second UE 115B or a third UE (not shown). As described above with reference to 535, the second UE 115B may relay/forward by a DF process or a AF process.

In some implementations, the second beam blockage response message is an aperiodic communication. For example, the beam blockage response message may be scheduled or triggered by a prior sidelink transmission. In other implementations, the second beam blockage response message is periodic, such as persistent, semi-persistent, etc. In such implementations, no scheduling message may be used which precedes the second beam blockage response message, however, a prior configuration or grant message can be used to allocate multiple transmission resources to the second UE 115B for the transmission of beam blockage response messages to the first UE 115A.

The first UE 115A receives the second beam blockage response message from the second UE 115B and determines information for upcoming operations based on the indication in the beam blockage response message and from the base station 105. For example, the UE 115 determines the resolution for the predicted beam blockage. To illustrate, the UE 115 determines what actions to take or refrain from for upcoming operations by the UE 115 and/or upcoming communications with the base station 105, such as uplink and downlink transmissions, based on the indication. As described above, the resolution may indicate one or more actions or adjustments for the first UE 115A to perform. In the example of FIG. 5, a beam adjustment is described.

At 555, the indication includes a beam adjustment and the first UE 115A adjusts a TCI state for an upcoming transmission to be a default TCI state for beam blockage or a TCI state explicitly indicated by the indicator of the second beam blockage response message. For example, the UE 115 switches to a default beam (which corresponds to a default TCI) and transmits or receives a communication using the default beam, performs a measurement using the default beam, reports the default beam or channel information associated with the default beam, or a combination thereof.

From 560 to 565, the first UE 115A performs one or more uplink and/or downlink operations with the base station 105 based on the indication. For example, the UE 115 transmits a first Uu communication (e.g., uplink communication) at 560 and/or receives a second Uu communication (e.g., downlink communication) at 565 using a previously configured/indicated default beam (default TCI state) or a beam (TCI state) indicated by the indication in the second beam blockage response message.

As other examples, the first UE 115A may operate using default or indicated (adjusted) BFD reference signals or with an adjusted periodicity. Alternatively, the first UE 115A may perform one or more other operations with another node or entity which is connected to the base station 105 to communicate with the base station 105 through another entity or via another channel different from the channel where the predicted blockage occurs. The other channel may be on another portion of the spectrum or in a different spectrum all together. The one or more other operations may include sidelink operations, such as with or via the second UE 115B, or uplink and/or downlink operations with another base station or another portion of the base station 105.

Although a blockage is shown during 560-565 in the example of FIG. 5, this is for illustrative or clarity and the blockage may occur any time. For example the blockage may start any time after 525. However, as illustrated in the example of FIG. 3B, the predicted blockage is between the first UE 115A and the base station 105 and not between the first UE 115A and the second UE 115B. Thus, the first UE 115A can still send transmissions to and receive transmissions from the second UE 115B, which is not experiencing the predicted blockage or expected to experience the predicted blockage. Accordingly, the first UE 115A may be able to provide the predicted beam blockage instance to the network and receive an indication for resolving the predicted beam blockage instance prior to beam or radio link failure.

Accordingly, in the example, of FIG. 5, a UE (e.g., the first UE 115A) which may not be able to reach the base station 105 (because of the blockage) can still inform the network of the blockage and receive resolution information from the network for overcoming or handling the blockage, such as without incurring beam or link failure.

Referring to FIG. 6, FIG. 6 is a timing diagram 600 illustrating a wireless communication system that supports sidelink assisted beam blockage prediction according to one or more aspects. The example of FIG. 6 may include or correspond to an example of sidelink assisted beam blockage prediction where a relay UE performs beam blockage prediction and the blocked UE performs the measurements used to obtain the prediction.

The example of FIG. 6 includes similar devices to the devices described in FIGS. 1, 2, and 4, such as a first UE 115A, a second UE 115B, and a network entity 605. The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate joint transmissions and receive the joint transmissions. In some implementations, network entity 505 may include or correspond to multiple TRPs of a single base station (e.g., base station 105), to multiple base stations, or any combination thereof.

At 610, the base station 105 transmits a beam blockage prediction configuration message to the second UE 115B. The beam blockage prediction configuration message includes beam blockage prediction configuration information. The beam blockage prediction configuration message may indicate or include information to configure the second UE 115B as a relay UE which also determines predicted beam blockages for one or more other UEs based on measurements received from the other UEs, such as the first UE 115A. In a particular implementation, the indication from the base station 105 identifies one or more UEs for the second UE 115B to act as a relay for, and optionally for which UEs it is to perform beam blockage prediction for.

At 615, optionally the second UE 115B transmits a beam blockage capabilities message to the first UE 115A. For example, the second UE 115B may transmit a sidelink transmission including beam blockage capability information. The beam blockage capability information may indicate that the second UE 115B is configured for sidelink relay of beam blockage message and for prediction of beam blockages. The sidelink transmission may include or correspond to a SL-RRC message, a SL-MAC-CE, SCI, a PSCCH, or a PSSCH. Alternatively, the base station 105 transmits beam blockage prediction configuration messages to both UEs, such as to first UE 115A in addition to the second UE 115B.

Optionally, the first UE 115A and/or the base station 105 may transmit an acknowledgement message responsive to the beam blockage configuration message or beam blockage capabilities message respectively. The acknowledgement message may indicate acknowledgement of successful receipt of the message and/or that the device is capable of the indicated mode or duty, measure, predict, relay, etc.

After beam blockage prediction configuration, the first UE 115A, the second UE 115B, and the base station 105 may engage in one or more operations at 620. For example, the base station 105 may perform one or more downlink related operations for the first UE 115A and/or the second UE 115B, as indicated by the Uu communications at 620 in the example of FIG. 6. As another example, the first and second UEs 115A and 115B may perform sidelink operations, such as transmit or receive one or more communications which utilize a PC5 communications interface or another communications interface for direct device-to-device communications.

In some implementations, the first UE 115A and the second UE 115B may transmit additional configuration message to adjust beam blockage prediction operations, such as to engage in or adjust periodic (e.g., semi-persistent) transmission of beam blockage messages. As indicated above, in the example of FIG. 6, the first UE 115A is configured to perform measurement operations and to provide measurement information to the second UE 115B, and the second UE 115B performs beam blockage prediction operations on its behalf, such as to determine beam blockage predictions for the first UE 115A. As compared to the example in FIG. 5, the example in FIG. 6 has the second UE 115B (e.g., relay UE) perform beam prediction as opposed to the first UE 115A (e.g., blocked UE). This may enable reduced capability devices, such as reduced processing power or battery power limited devices, to still perform beam blockage prediction operations with the help of another UE.

At 625, the first UE 115A may perform one or more measurement operations. For example, the first UE 115A may perform one or more measurement operations on one or more downlink transmissions, such as reference signals thereof, during the first UE's 115A operations with the base station 105 at 620 to generate measurement information. The measurement information may include or correspond to the measurement information described with reference to FIG. 4, such as measurement data 408. To illustrate, the measurement information may include layer one, physical layer, measurements of RSRP and other quantities generated from the downlink or uplink operations performed after beam blockage prediction configuration.

At 630, the first UE 115A transmits a beam blockage measurement message to the second UE 115B via a sidelink channel for beam blockage prediction operations, also referred to herein as a beam blockage prediction message. The beam blockage measurement message may be sent via a first type of communications interface (e.g., a Uu interface or a PC5 interface) and may include or correspond to a SCI, a SCI-MAC-CE, or a SL-RRC. For example, the first UE 115A may transmit a beam blockage measurement message including measurement information which may be indicative of a beam blockage instance and for further beam blockage prediction processing by the second UE 115B. The beam blockage measurement message includes beam blockage measurement information, such as described with reference to FIG. 4. The beam blockage measurement information may include RSRP measurement information or parameters derived from the RSRP measurement information, as illustrative, non-limiting examples.

In some implementations, the beam blockage measurement message is an aperiodic communication. For example, the beam blockage measurement message may be scheduled or triggered by a prior sidelink transmission (for UE scheduled sidelink, such as a SCI or PSCCH) or downlink transmission (for network scheduled sidelink, such as a DCI or PDCCH). In other implementations, the beam blockage measurement message is periodic, such as persistent, semi-persistent, etc. In such implementations, no scheduling (e.g., trigger) message may be used which precedes the beam blockage measurement message, however, a prior configuration or grant message (e.g., activation message) can be used to allocate multiple transmission resources to the first UE 115A for the transmission of multiple beam blockage measurement messages.

At 635, the second UE 115B may determine a predicted beam blockage instance. For example, the second UE 115B may receive the beam blockage measurement message, decode the message to obtain measurement information, and determine, estimate or predict a predicted beam blockage instance for the first UE 115A based on the measurement information received from the first UE 115A. For example, the second UE 115B may determine a predicted beam blockage instance based on the measurement information included in the beam blockage measurement message, such as raw layer 1 measurements, or based on information derived from the measurement information, such as time and/or spatial variances of particular quantities of the measurement information and associated with a number of downlink reference signals. This derived information may alternatively include or correspond to RSRP fingerprint information and may be matched with stored model RSRP fingerprint data to predict an upcoming blockage.

To illustrate, the second UE 115B determines the predicted beam blockage instance based on AI or ML operations or AI or ML model data. As an illustrative example, the second UE 115B may generate an RSRP fingerprint based on the measurement information and compare the RSRP fingerprint to stored RSRP fingerprints which are associated with past beam blockages for the first UE 115A, the second UE 115B, other UEs, or a combination thereof. Based on the comparison indicating a match, a match within threshold level (e.g., high correlation), or finding a quantity of similar markers above of threshold, the second UE 115B may predict a beam blockage instance. In some implementations, the second UE 115B further determines details of the predicted beam blockage instance based on the measurement information or the AI/ML information.

At 635, the second UE 115B transmits a beam blockage prediction message to the base station 105 via an uplink channel. For example, the second UE 115B generates a beam blockage prediction message based on the predicted beam blockage instance and transmits the beam blockage prediction message to the base station 105 via PUCCH or PUSCH. To illustrate, the second UE 115B may transmit a beam blockage prediction message including beam blockage prediction indicator which is configured to indicate that a predicted beam blockage instance has been detected. This indicator may include or correspond to a single bit in some implementations. As another illustration, the second UE 115B may transmit a beam blockage prediction message including beam blockage prediction information which indicates or identifies information about the predicted beam blockage instance. To illustrate, the beam blockage prediction information may include the information described with reference to FIG. 4, such as beam blockage instance information, identifier information for the first UE 115A, serving cell identifier information, or a combination thereof. The beam blockage instance information may include starting time information, duration information, severity information, blockage direction information, or a combination thereof. The second UE 115B may transmit the beam blockage prediction message via a second type of communications interface (e.g., Uu interface) that is different from the first type of communication interface (e.g., PC5 interface) used to receive the beam blockage measurement message.

In some implementations, the beam blockage prediction message is an aperiodic communication. For example, the beam blockage prediction message may be scheduled or triggered by a prior downlink transmission from the network, such as an uplink grant DCI. In other implementations, the beam blockage prediction message is periodic, such as persistent, semi-persistent, etc. In such implementations, no scheduling (e.g., trigger) message may be used which precedes the beam blockage prediction message, however, a prior configuration or grant message (e.g., activation message) can be used to allocate multiple transmission resources to the second UE 115B for the transmission of multiple beam blockage prediction messages to the network (e.g., base station 105).

At 645, the base station 105 receives the beam blockage prediction for the first UE 115A from the second UE 115B, and the base station 105 determines a resolution for the predicted beam blockage instance for the first UE 115A, as described with reference to FIGS. 4 and 540 of FIG. 5. The remaining operations of FIG. 6 may be similar to their corresponding operations in FIG. 4 and/or FIG. 5.

At 650, the base station 105 transmits a beam blockage response message to the second UE 115B including an indication for resolution of the predicted beam blockage instance for the first UE 115A. For example, the base station 105 may transmit an indication for the first UE 115A to the second UE 115B for relaying or delivering to the first UE 115A. The indication may indicate or identify the determined resolution from 540 and as described with reference to FIG. 4. The beam blockage response message may be sent via the same type of communications interface (e.g., a Uu interface) used to receive the beam blockage prediction message and may include or correspond to a downlink channel transmission, such as DCI, MAC-CE, PDCCH, PDSCH, etc.

In some implementations, the beam blockage response message corresponds to a group of UEs and includes a first indication for the first UE 115A and a second indication for another UE, such as the second UE 115B or a third UE (not shown). In some such implementations, each indication may correspond to a predicted beam blockage instance for a particular UE and indications for multiple UEs may be included, along with a corresponding identifier, in the beam blockage response message. Thus, the second UE 115B may decode the beam blockage response message and determine which indications should be sent (e.g., forwarded or relayed) where.

At 655, the second UE 115B receives the beam blockage response message from the base station 105 via a downlink channel and transmits a second beam blockage response message to the first UE 115A via a sidelink channel. For example, the second UE 115B receives the beam blockage response message and transmits (forwards or relays) the beam blockage response message to the first UE 115A via PSCCH or PSSCH. The second beam blockage response message be sent via either type of communications interface (e.g., a Uu interface or a PC5 interface) and optionally via the first type of communications interface used to send the beam blockage measurement message. As another example, the second UE 115B receives the beam blockage response message and decodes (at least partially) the beam blockage response message. The second UE 115B may generate a second beam blockage response message based on the decoded beam blockage response message. The second UE 115B then transmits the second beam blockage response message, which is different than the beam blockage prediction message, to the base station 105 via PUCCH or PUSCH. The second beam blockage response message may include or correspond to an amplified beam blockage response message, a modified beam blockage response message, or a combination thereof. For example, the second beam blockage response message may include beam blockage responses for multiple other UEs, such as the first UE 115A and the second UE 115B or a third UE (not shown). As described above with reference to 535, the second UE 115B may relay/forward by a DF process or a AF process.

In some implementations, the second beam blockage response message is an aperiodic communication. For example, the beam blockage response message may be scheduled or triggered by a prior sidelink transmission. In other implementations, the second beam blockage response message is periodic, such as persistent, semi-persistent, etc. In such implementations, no scheduling message may be used which precedes the second beam blockage response message, however, a prior configuration or grant message can be used to allocate multiple transmission resources to the second UE 115B for the transmission of beam blockage response messages to the first UE 115A.

The first UE 115A receives the second beam blockage response message from the second UE 115B and determines resolution information for upcoming operations based on the indication in the beam blockage response message and from the base station 105. For example, the UE 115 determines the resolution action or actions for upcoming operations or communications with the base station 105, such as uplink and downlink transmissions, Uu operations, or a combination thereof, based on the indication. As described above, the resolution may indicate one or more actions or adjustments for the first UE 115A to perform.

From 660 to 665, the first UE 115A performs one or more uplink and/or downlink operations with the base station 105 based on the indication. For example, the UE 115 receives a first Uu communication (e.g., downlink communication) at 660 and/or transmits a second Uu communication (e.g., uplink communication) at 665 using a previously configured/indicated default beam (default TCI state) or a beam (TCI state) indicated by the indication in the second beam blockage response message.

As other examples, the first UE 115A may operate using default or indicated (adjusted) BFD reference signals or with an adjusted periodicity. Alternatively, the first UE 115A may perform one or more other operations with another node or entity which is connected to the base station 105 to communicate with the base station 105 through another entity or via another channel different from the channel where the predicted blockage occurs. The other channel may be on another portion of the spectrum or in a different spectrum all together. The one or more other operations may include sidelink operations, such as with or via the second UE 115B, or uplink and/or downlink operations with another base station or another portion of the base station 105.

Although a blockage is shown during 660-665 in the example of FIG. 6, this is for illustrative or clarity and the blockage may occur any time. For example the blockage may start any time after 625. However, as illustrated in the example of FIG. 3B, the predicted blockage is between the first UE 115A and the base station 105 and not between the first UE 115A and the second UE 115B. Thus, the first UE 115A can still send transmissions to and receive transmissions from the second UE 115B, which is not experiencing the predicted blockage or expected to experience the predicted blockage. In addition to the example of FIG. 5, in the example of FIG. 6, the first UE 115A can still participate in sidelink assisted beam blockage prediction even though it might be incapable of beam blockage prediction or not be configured for beam blockage at that time. Accordingly, the first UE 115A may be able to provide measurement information to another UE which causes a predicted beam blockage instance to be delivered to the network, and the first UE 115A receives an indication for resolving the predicted beam blockage instance prior to beam or radio link failure.

Accordingly, in the example, of FIG. 6, a UE (e.g., the first UE 115A) which may not be able to reach the base station 105 (because of the blockage) or even predict the blockage, can still inform the network of an upcoming blockage and receive resolution information from the network for overcoming or handling the upcoming blockage, such as without incurring beam or link failure.

Although the beam blockage measurement information (also referred to as measurement information), the beam blockage prediction information, and the beam blockage resolution information are described with reference to discrete messages or transmissions by the same name in the examples of FIGS. 4-6, in other implementations one or more of the beam blockage measurement information, the beam blockage prediction information, and the beam blockage resolution information may be sent via other messages or transmissions. The description of the transmission of beam blockage related information in corresponding beam blockage messages and transmissions in the examples of FIGS. 4-6 represents one implementation and is for simplicity and ease of description. In practice, beam blockage related information may be sent in other messages or transmissions and may be included in with other types of information. For example, beam blockage measurement information or prediction information may be sent with general channel reporting information. As another example, resolution information may be transmitted with control information, such as channel or device configuration information.

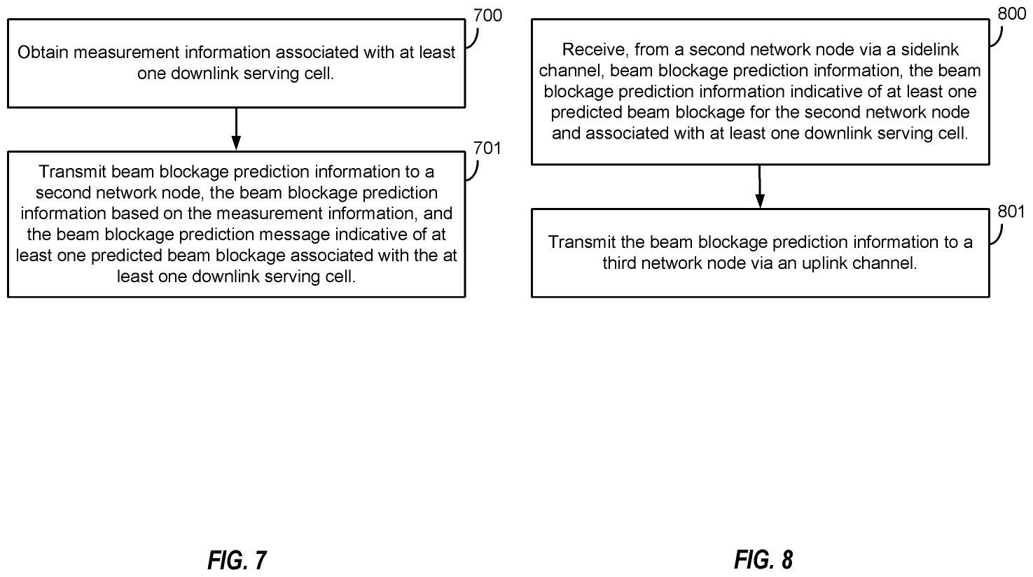

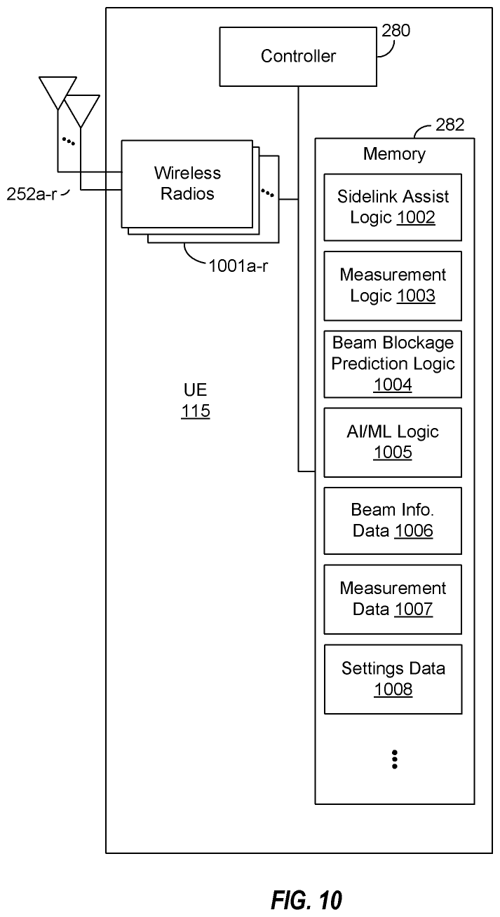

FIG. 7 is a flow diagram illustrating example blocks executed by a wireless communication device (e.g., a UE or base station) configured according to an aspect of the present disclosure. The example blocks will also be described with respect to UE 115 as illustrated in FIG. 10. FIG. 10 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1001a-r and antennas 252a-r. Wireless radios 1001a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 10, memory 282 stores sidelink assist logic 1002, measurement logic 1003, beam blockage prediction logic 1004, AI/ML logic 1005, beam information data 1006, measurement data 1007, and settings data 1008. The data (1002-1008) stored in the memory 282 may include or correspond to the data (406, 408, 442, and/or 444) stored in the memory 404 of FIG. 4.

At block 700, a wireless communication device, such as a UE, obtains measurement information associated with at least one downlink serving cell. For example, the UE (e.g., UE 115) may generate the measurement information itself by performing measurements or the UE (e.g., 403) may receive the measurement information from another UE (e.g., UE 115).

When the measurement information is generated locally, the UE may perform one or more downlink channel measurements associated with at least one downlink serving cell to generate the measurement information. For example, the UE 115 performs one or more measurements operations as described with reference to FIGS. 4-6. To illustrate, the UE 115 may perform CSI or CSF related measurements, such as layer 1 or physical layer measurements, on downlink reference signals received in downlink communications from a base station. The measurements may include RSRP, RSRQ, SINR, etc. In some implementations, the UE may use the measurements to generate or derive metric information, such as time or spatial variance of measured parameters/quantities.

When the measurement information is received from another UE, the UE may receive the information via a sidelink channel. For example, the UE 115 receives a beam blockage measurement message from another UE in which includes the measurement information. The measurement information is indicative of a beam blockage in the future for the other UE, as described with reference to FIGS. 4 and 6. The beam blockage measurement message may include or correspond to the first beam blockage prediction message 452 of FIG. 4, or the beam blockage measurement message of FIG. 6, as described with reference to FIGS. 4 and 6. To illustrate, a receiver (e.g., receiver processor 258 or receiver 412) of the second UE 403 receives the first beam blockage prediction message 452 (or measurement message) from the UE 115 via wireless radios 1001a-r and antennas 252a-r which includes measurement information or metrics derived from measurement information generated by the UE 115.

At block 701, the UE transmits beam blockage prediction information to a second network node, the beam blockage prediction information based on the measurement information, and the beam blockage prediction message indicative of at least one predicted beam blockage associated with the at least one downlink serving cell. For example, the UE may transmit the beam blockage prediction information in a message to another UE, such as UE 403, or to a network device, such as base station 105.

When the UE transmits the beam blockage prediction information to another UE, the UE may transmit, based on the measurement information, a beam blockage prediction message via a sidelink channel to a second network node, the beam blockage prediction message indicating a future predicted blockage for the downlink serving cell. For example, the UE 115 transmits a beam blockage prediction message including a beam blockage prediction indicator or beam blockage prediction information, as described with reference to FIGS. 4 and 5. The beam blockage prediction message may include or correspond to the first beam blockage prediction message 452 of FIG. 4, or the first beam blockage prediction message of FIG. 5, as described with reference to FIGS. 4 and 5. To illustrate, a transmitter (e.g., transmit processor 264 or transmitter 410) of the UE 115 transmits the first beam blockage prediction message 452 via wireless radios 1001a-r and antennas 252a-r which includes an indication of the predicted beam blockage or which includes beam blockage prediction information which describes the predicted beam blockage instance. In some implementations, the UE generates, such as determines, estimates, or predicts, the beam blockage prediction based performing artificial intelligence—or machine learning-assisted beam blockage prediction techniques or using artificial intelligence—or machine learning-generated data sets. For example, the UE may use RSRP fingerprinting methods for beam blockage prediction.

When the UE transmits the beam blockage prediction information to a network device, the UE may transmit, based on the measurement information, beam blockage prediction information to base station 105 via a uplink channel and indicating a prediction for the beam blockage for another UE. For example, the second UE 403 transmits a beam blockage prediction message including a beam blockage prediction indicator or beam blockage prediction information to the network for the UE 115, as described with reference to FIGS. 4 and 6. The beam blockage prediction message may include or correspond to the second beam blockage prediction message 454 of FIG. 4, or the beam blockage prediction message of FIG. 6, as described with reference to FIGS. 4 and 6. To illustrate, a transmitter (e.g., transmit processor 264 or transmitter 410) of the second UE transmits the second beam blockage prediction message 454 (or the beam blockage prediction message of FIG. 6) via wireless radios 1001a-r and antennas 252a-r which includes an indication of the predicted beam blockage or which includes beam blockage prediction information which describes the predicted beam blockage instance. In some implementations, the UE generates, such as determines, estimates, or predicts, the beam blockage prediction based performing artificial intelligence-or machine learning-assisted beam blockage prediction techniques or using artificial intelligence-or machine learning-generated data sets. For example, the UE may use RSRP fingerprinting methods for beam blockage prediction.

The wireless communication device (e.g., UE or base station) may execute additional blocks (or the wireless communication device may be configured further perform additional operations) in other implementations. For example, the wireless communication device (e.g., the UE 115) may perform one or more operations described above. As another example, the wireless communication device (e.g., the UE 115) may perform one or more aspects as presented below.

In a first aspect, obtaining the measurement information includes generating the measurement information. For example, the first network node may perform one or more measurements to generate first measurement information (e.g., directly measured values, such as RSRP). The first network node may process the first measurement information to generate second measurement information (e.g., non-direct values, such as SNR). The obtained information may include the first measurement information, the second measurement information, or a combination thereof.

In a second aspect, alone or in combination with the first aspect, obtaining the measurement information includes receiving the measurement information from a third network node, the measurement information corresponding to measurement information generated or derived by the third network node.

In a third aspect, alone or in combination with one or more of the above aspects, the beam blockage prediction information includes a future predicted beam blockage instance corresponding to the at least one predicted beam blockage associated with the at least one downlink serving cell.

In a fourth aspect, alone or in combination with one or more of the above aspects, the first network node (e.g., UE 115) further determines the future predicted beam blockage instance based on the measurement information, wherein the measurement information includes reference signal received power (RSRP) information corresponding to with the at least one downlink serving cell.

In a fifth aspect, alone or in combination with one or more of the above aspects, determining the future predicted beam blockage instance based on the measurement information includes: input the measurement information into a model configured to predict information associated with the input to the model; and obtain, as an output from the model, the future predicted beam blockage instance.

In a sixth aspect, alone or in combination with one or more of the above aspects, the first network node further: receives beam blockage response information from the second network node, wherein the beam blockage response information includes a blockage resolution indication from a third network node associated with the at least one downlink serving cell, and wherein the blockage resolution indication corresponds to a resolution for the first network node for the at least one predicted beam blockage; and transmits or receives a transmission from the third network node during the at least one predicted beam blockage based on the blockage resolution indication.

In a seventh aspect, alone or in combination with one or more of the above aspects, the first network node further: receives beam blockage response information from the second network node, wherein the beam blockage response information includes a blockage resolution indication for a third network node, and wherein the blockage resolution indication corresponds to a resolution for the third network node for the at least one predicted beam blockage; and transmits the beam blockage response information to the third network node via a sidelink channel, wherein the blockage resolution indication enables the third network node to communicate with the second network node during the at least one predicted beam blockage.

In an eighth aspect, alone or in combination with one or more of the above aspects, the first network node is a first user equipment (UE), and wherein the second network node is a second UE or a base station.

In a ninth aspect, alone or in combination with one or more of the above aspects, the first network node further receives beam blockage prediction configuration information from a third network node, wherein transmitting the beam block prediction information to the second network node includes transmitting based on the beam blockage prediction configuration information to the second network node, wherein the measurement information is based on the beam blockage prediction configuration information.

In a tenth aspect, alone or in combination with one or more of the above aspects, the first network node further: transmits beam blockage prediction capability information or a beam blockage prediction request to a third network node, wherein the beam blockage prediction capability information is indicative of a capability of the first network node to predict future beam blockages, and wherein the beam blockage prediction request indicates a request for an indication of another network node which is capable of predicting future beam blockages; and receives, responsive to the beam blockage prediction capability information or the beam blockage prediction request, an acknowledgement from the third network node, wherein the measurement information is based on the acknowledgement.

In an eleventh aspect, alone or in combination with one or more of the above aspects, the beam blockage prediction capability information includes beam blockage measurement capability information, power headroom information, coverage information, node type information, or a combination thereof.

In a twelfth aspect, alone or in combination with one or more of the above aspects, the first network node further transmits a beam blockage prediction request to the second network node after receipt of a first acknowledgement from a third network node or after receipt of beam blockage prediction configuration information from the third network node; and receives a second acknowledgement from the second network node, wherein the measurement information is based on the first acknowledgement, and wherein transmitting the beam blockage prediction information includes transmitting the beam blockage prediction information based on the first acknowledgement.

In a thirteenth aspect, alone or in combination with one or more of the above aspects, the beam blockage prediction information is included in sidelink control information (SCI), a sidelink medium access control (MAC) control element (CE) (SL-MAC CE), or a sidelink radio resource control (SL-RRC) message.

In a fourteenth aspect, alone or in combination with one or more of the above aspects, the beam blockage prediction information is included in a sidelink medium access control (MAC) control element (CE) (SL-MAC CE), and the first network node further transmits, prior to the transmission of the SL-MAC-CE, sidelink control information (SCI) scheduling the SL-MAC-CE.

In a fifteenth aspect, alone or in combination with one or more of the above aspects, the beam blockage prediction information includes serving cell identification information that identifies each respective downlink serving cell of the at least one downlink serving cell where a respective beam blockage of the at least one predicted beam blockage is predicted to occur.

In a sixteenth aspect, alone or in combination with one or more of the above aspects, the first network node further receives, from the second network node or a third network node associated with the at least one downlink serving cell, an indication of a default transmission configuration information (TCI) state to use for the at least one predicted beam blockage.

In a seventeenth aspect, alone or in combination with one or more of the above aspects, the first network node further transmits a communication to the third network node using the default TCI state for the at least one predicted beam blockage. The default TCI state can be for the same serving cell as the blockage or for a different serving cell, including for primary or secondary cells.

In an eighteenth aspect, alone or in combination with one or more of the above aspects, the beam blockage prediction information includes: beam blockage instance information including starting time information, duration information, severity information, blockage direction information, or a combination thereof for a future predicted beam blockage instance corresponding to the at least one predicted beam blockage associated with the at least one downlink serving cell; the measurement information, wherein the measurement information includes at least one of reference signal receive power (RSRP) measurement information or parameters derived from the RSRP measurement information for the first network node; identifier information for the first network node; serving cell identifier information including respective identifier information for each respective downlink serving cell of the at least one downlink serving cell; or a combination thereof.

In a nineteenth aspect, alone or in combination with one or more of the above aspects, transmitting the beam blockage prediction information includes transmitting the beam blockage prediction information via a sidelink channel.

In a twentieth aspect, alone or in combination with one or more of the above aspects, the first network node (e.g., UE 115) further determines whether uplink pathloss information associated with the at least one downlink serving cell satisfies one or more conditions, wherein the transmission of the beam blockage prediction information is based on the determination, and wherein determining whether the uplink pathloss information satisfies the one or more conditions includes: comparing a first uplink pathloss value, for a first downlink serving cell of the at least one downlink serving cell, to a first uplink pathloss threshold associated with a first condition for the first downlink serving cell; and comparing a second uplink pathloss value, for a second downlink serving cell of the at least one downlink serving cell, to a second uplink pathloss threshold associated with a second condition for the second downlink serving cell.

In a twenty-first aspect, alone or in combination with one or more of the above aspects, the first network node (e.g., UE 115) further determines the first uplink pathloss threshold based on a payload size of the beam blockage prediction information.

In a twenty-second aspect, alone or in combination with one or more of the above aspects, the first network node (e.g., UE 115) further receives, prior to the transmission of the beam blockage prediction information, beam blockage prediction capability information from the second network node, wherein the beam blockage prediction capability information includes an indication of a beam blockage prediction relay capability of the second network node, an indication of a beam blockage prediction capability of the second network node, or both.

In a twenty-third aspect, alone or in combination with one or more of the above aspects, transmitting the beam blockage prediction information includes transmitting an aperiodic transmission including the beam blockage prediction information, and the first network node further: transmits a scheduling indication to the second network node indicating the beam blockage prediction information.

In a twenty-fourth aspect, alone or in combination with one or more of the above aspects, transmitting the beam blockage prediction information includes transmitting a first semi-persistent transmission including the beam blockage prediction information, and the first network node further: transmits a scheduling request for a plurality of semi-persistent transmissions including the first semi-persistent transmission to the second network node, wherein the scheduling request includes periodicity information and offset information for semi-persistent transmission of the plurality of a semi-persistent transmissions; and transmits a scheduling indication for the beam blockage prediction information to the second network node based on the scheduling request after receipt of an acknowledge from the second network node or expiration of timer associated with the scheduling request.

Accordingly, wireless communication devices may perform sidelink assisted beam blockage prediction operations for wireless communication devices. By performing sidelink assisted beam blockage prediction beam and radio link failures can be reduced which increases throughput and reduces latency, errors and overhead.

FIG. 8 is a flow diagram illustrating example blocks executed wireless communication device (e.g., a UE or network entity, such as a base station) configured according to an aspect of the present disclosure. The example blocks will also be described with respect to UE 115 as illustrated in FIG. 10 and described above.

At block 800, a wireless communication device, such as a network device (e.g., a base station 105), receive, from a second network node via a sidelink channel, beam blockage prediction information, the beam blockage prediction information indicative of at least one predicted beam blockage for the second network node and associated with at least one downlink serving cell. For example, the second UE 403 receives a beam blockage prediction message from another UE which includes beam blockage prediction information which is indicative of a beam blockage in the future for the other UE, as described with reference to FIGS. 4 and 5. The beam blockage measurement message may include or correspond to the first beam blockage prediction message 452 of FIG. 4, or the first beam blockage measurement message of FIG. 5, as described with reference to FIGS. 4 and 5. To illustrate, a receiver (e.g., receiver processor 258 or receiver 412) of the second UE 403 receives the first beam blockage prediction message 452 (or measurement message) from the UE 115 via wireless radios 1001a-r and antennas 252a-r which includes measurement information or metrics derived from measurement information generated by the UE 115.

At block 801, the wireless communication device transmits the beam blockage prediction information to a third network node via an uplink channel. For example, the second UE 403 transmits beam blockage prediction information, such as in a beam blockage prediction message or by a beam blockage prediction indicator, to the network, as described with reference to FIGS. 4 and 5. The beam blockage prediction message may include or correspond to the second beam blockage prediction message 454 of FIG. 4, or the second beam blockage prediction message of FIG. 5, as described with reference to FIGS. 4 and 5. To illustrate, a transmitter (e.g., transmit processor 264 or transmitter 410) of the second UE 403 transmits the second beam blockage prediction message 454 (or second the beam blockage prediction message of FIG. 5) via wireless radios 1001a-r and antennas 252a-r which includes an indication of the predicted beam blockage or which includes beam blockage prediction information which describes the predicted beam blockage instance.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-7 and as presented below.

In a first aspect, the first network node is configured to receive second beam blockage prediction information for other network nodes and relay the second beam blockage prediction information to the third network node.

In a second aspect, alone or in combination with the first aspect, the first network node (e.g., second UE 403) further: receives, from the third network node, a beam blockage response responsive to the beam blockage prediction information, wherein the beam blockage response includes information indicative of a modified transmission setting configuration for the second network node and a first identifier for the second network node; and transmits a beam blockage response indication to the second network node based on the beam blockage response.

In a third aspect, alone or in combination with one or more of the above aspects, the beam blockage response is included in downlink control information (DCI) or a physical downlink shared channel (PDSCH) transmission, and the beam blockage response includes an identifier for the second network node.

In a fourth aspect, alone or in combination with one or more of the above aspects, receiving the beam blockage response includes receiving the beam blockage response via a physical downlink shared channel (PDSCH), and wherein the beam blockage response includes multiple beam blockage response indications associated with multiple network nodes.

In a fifth aspect, alone or in combination with one or more of the above aspects, the first network node further: determines, based on the beam blockage response, a second network node identifier for a fourth network node, the second network node identifier associated with a respective indication of the multiple beam blockage response indications; and transmits a second beam blockage response corresponding to the second network node identifier to the fourth network node. Determining network node identifiers may include decoding the beam blockage response message; parsing the decoded beam blockage response message to determine network node identifiers, including a first network node identifier for the second network node and a second network node identifier for a fourth network node, associated with each indication of the multiple beam blockage response indications.

In a sixth aspect, alone or in combination with one or more of the above aspects, the beam blockage response indication comprises one or more transmission configuration indicator (TCI) state identifiers for the second network node, wherein each respective TCI state identifier of the one or more TCI state identifiers is associated with one or more respective control resource sets (CORESETs) associated with second network node.

In a seventh aspect, alone or in combination with one or more of the above aspects, the beam blockage response indication comprises one or more beam failure detection (BFD) reference signal (RS) (BFD-RS) identifiers associated with the second network node.

In an eighth aspect, alone or in combination with one or more of the above aspects, the beam blockage response indication comprises an adjustment to a periodicity of semi-periodic beam blockage prediction measurements or semi-periodic beam blockage prediction messages for the second network node.

Accordingly, wireless communication devices may perform sidelink assisted beam blockage prediction operations for wireless communication devices. By performing sidelink assisted beam blockage prediction beam and radio link failures can be reduced which increases throughput and reduces latency, errors and overhead.

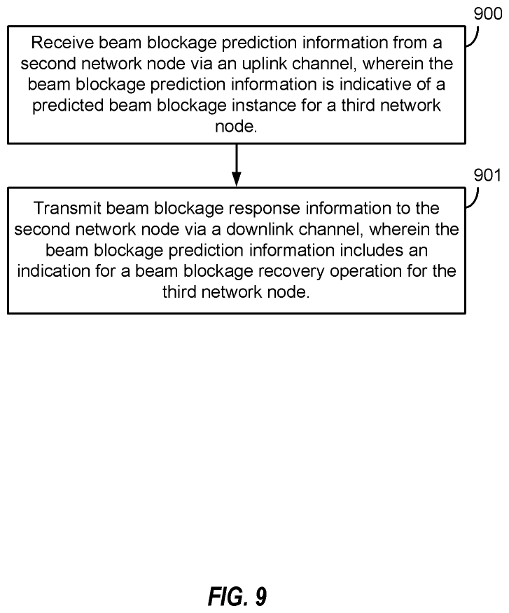

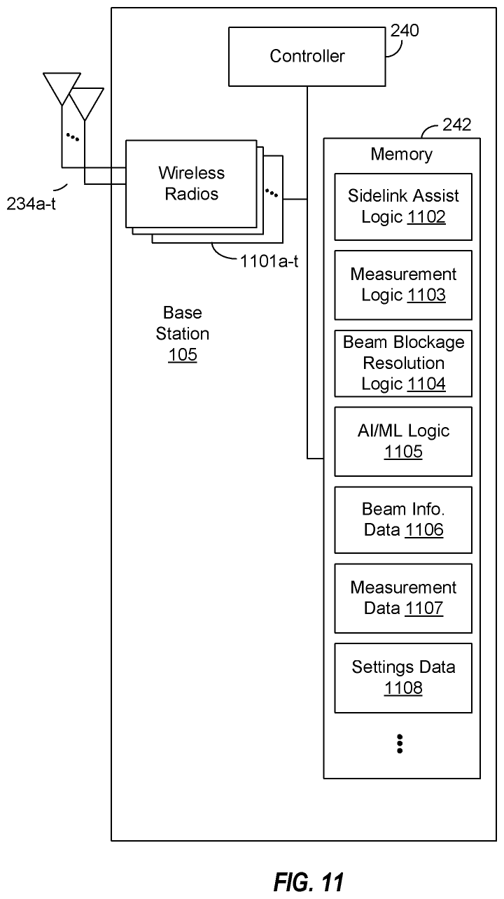

FIG. 9 is a flow diagram illustrating example blocks executed wireless communication device (e.g., a UE or network entity, such as a base station) configured according to an aspect of the present disclosure. The example blocks will also be described with respect to base station 105 as illustrated in FIG. 11. FIG. 11 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1101a-t and antennas 234a-t. Wireless radios 1101a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 11, memory 242 stores sidelink assist logic 1102, measurement logic 1103, beam blockage resolution logic 1104, AI/ML logic 1105, beam information data 1106, measurement data 1107, and settings data 1108. The data (1102-1108) stored in the memory 242 may include or correspond to the data (406, 409, 442, and/or 444) stored in the memory 432 of FIG. 4.

At block 900, a wireless communication device, such as a network device (e.g., a base station 105), receives beam blockage prediction information from a second network node via an uplink channel, wherein the beam blockage prediction information is indicative of a predicted beam blockage instance for a third network node. For example, the base station 105 receives a beam blockage prediction message from a first UE (e.g., relay UE, second UE 403) which includes beam blockage prediction information which is indicative of a beam blockage in the future for a second UE (e.g., a blocked UE, UE 115), as described with reference to FIGS. 4-6. The beam blockage prediction message may include or correspond to the second beam blockage prediction message 454 of FIG. 4, or the second beam blockage prediction message of FIG. 5 or 6, as described with reference to FIGS. 4-6. To illustrate, a receiver (e.g., receiver processor 238 or receiver 436) of the base station 105 receives the second beam blockage prediction message 454 from the second UE 403 via wireless radios 1101a-t and antennas 234a-t which includes beam blockage prediction information which is generated based on measurement information or metrics derived from measurement information generated by the UE 115. In some implementations, the UE 115 generates the beam blockage prediction information. In other implementations, the second UE 403 generates the beam blockage prediction information.

At block 901, the wireless communication device transmits beam blockage response information to the second network node via a downlink channel, wherein the beam blockage prediction information includes an indication for a beam blockage recovery operation for the third network node. For example, the base station transmits a beam blockage response (e.g., beam blockage response message) including a beam blockage resolution (resolution indicator or information) to a relay UE, as described with reference to FIGS. 4-6. The beam blockage response or response message may include or correspond to the first beam blockage response message 456 of FIG. 4, or the first beam blockage response message of FIG. 5 or 6, as described with reference to FIGS. 4-6. To illustrate, a transmitter (e.g., transmit processor 220/TX MIMO processor 230 or transmitter 434) of the base station 105 transmits the first beam blockage response message 456 via wireless radios 1101a-t and antennas 234a-t which includes an indication of the beam blockage resolution or which includes beam blockage resolution information which describes a resolution actions for the predicted beam blockage instance. In some implementations, the network generates, such as determines, estimates, or predicts, the resolution for the predicted beam blockage based performing artificial intelligence-or machine learning-assisted beam blockage resolution techniques or using artificial intelligence-or machine learning-generated data sets.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-8 and as presented below.

In a first aspect, the first network node (e.g., base station 105) is further configured to: transmit or receive a transmission based on the beam blockage response message using modified transmission settings; or perform a beam blockage recovery operation based on the beam blockage response message.

Accordingly, wireless communication devices may perform sidelink assisted beam blockage prediction operations for wireless communication devices. By performing sidelink assisted beam blockage prediction beam and radio link failures can be reduced which increases throughput and reduces latency, errors and overhead.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node for wireless communication, comprising:
at least one processor; and
a memory coupled to the at least one processor,
wherein the at least one processor is configured to:
obtain measurement information associated with at least one downlink serving cell; and
transmit beam blockage prediction information to a second network node, wherein the beam blockage prediction information is based on the measurement information, and wherein the beam blockage prediction information is indicative of at least one predicted beam blockage associated with the at least one downlink serving cell.

2. The first network node of claim 1, wherein, to obtain the measurement information, the at least one processor is configured to generate the measurement information.

3. The first network node of claim 1, wherein, to obtain the measurement information, the at least one processor is configured to receive the measurement information from a third network node, the measurement information corresponding to measurement information generated or derived by the third network node.

4. The first network node of claim 1, wherein the beam blockage prediction information includes a future predicted beam blockage instance corresponding to the at least one predicted beam blockage associated with the at least one downlink serving cell.

5. The first network node of claim 4, wherein the at least one processor is configured to:
determine the future predicted beam blockage instance based on the measurement information, wherein the measurement information includes reference signal received power (RSRP) information corresponding to with the at least one downlink serving cell.

6. The first network node of claim 5, wherein, to determine the future predicted beam blockage instance based on the measurement information, the at least one processor is configured to:
input the measurement information into a model configured to predict information associated with the input to the model; and
obtain, as an output from the model, the future predicted beam blockage instance.

7. The first network node of claim 1, wherein the at least one processor is configured to:
receive beam blockage response information from the second network node, wherein the beam blockage response information includes a blockage resolution indication from a third network node associated with the at least one downlink serving cell, and wherein the blockage resolution indication corresponds to a resolution for the first network node for the at least one predicted beam blockage; and
transmit or receive a transmission from the third network node during the at least one predicted beam blockage based on the blockage resolution indication.

8. The first network node of claim 1, wherein the at least one processor is configured to:
receive beam blockage response information from the second network node, wherein the beam blockage response information includes a blockage resolution indication for a third network node, and wherein the blockage resolution indication corresponds to a resolution for the third network node for the at least one predicted beam blockage; and
transmit the beam blockage response information to the third network node via a sidelink channel, wherein the blockage resolution indication enables the third network node to communicate with the second network node during the at least one predicted beam blockage.

9. The first network node of claim 1, wherein the first network node is a first user equipment (UE), and wherein the second network node is a second UE or a base station.

10. The first network node of claim 1, wherein the at least one processor is configured to:
receive beam blockage prediction configuration information from a third network node, wherein, to transmit the beam block prediction information to the second network node, the at least one processor is configured to transmit, based on the beam blockage prediction configuration information to the second network node, wherein the measurement information is based on the beam blockage prediction configuration information.

11. The first network node of claim 1, wherein the at least one processor is configured to:
transmit beam blockage prediction capability information or a beam blockage prediction request to a third network node, wherein the beam blockage prediction capability information is indicative of a capability of the first network node to predict future beam blockages, and wherein the beam blockage prediction request indicates a request for an indication of another network node which is capable of predicting future beam blockages; and
receive, responsive to the beam blockage prediction capability information or the beam blockage prediction request, an acknowledgement from the third network node, wherein the measurement information is based on the acknowledgement.

12. The first network node of claim 11, wherein the beam blockage prediction capability information includes beam blockage measurement capability information, power headroom information, coverage information, node type information, or a combination thereof.

13. The first network node of claim 1, wherein the at least one processor is configured to:
transmit a beam blockage prediction request to the second network node after receipt of a first acknowledgement from a third network node or after receipt of beam blockage prediction configuration information from the third network node; and
receive a second acknowledgement from the second network node, wherein the measurement information is based on the first acknowledgement, and wherein, to transmit the beam blockage prediction information, the at least one processor is configured to transmit the beam blockage prediction information based on the first acknowledgement.

14. The first network node of claim 1, wherein the beam blockage prediction information is included in sidelink control information (SCI), a sidelink medium access control (MAC) control element (CE) (SL-MAC CE), or a sidelink radio resource control (SL-RRC) message.

15. The first network node of claim 1, wherein the beam blockage prediction information is included in a sidelink medium access control (MAC) control element (CE) (SL-MAC CE), and wherein the at least one processor is configured to:
transmit, prior to the transmission of the SL-MAC-CE, sidelink control information (SCI) scheduling the SL-MAC-CE.

16. The first network node of claim 1, wherein the beam blockage prediction information includes serving cell identification information that identifies each respective downlink serving cell of the at least one downlink serving cell where a respective beam blockage of the at least one predicted beam blockage is predicted to occur.

17. The first network node of claim 16, wherein the at least one processor is configured to:
receive, from the second network node or a third network node associated with the at least one downlink serving cell, an indication of a default transmission configuration information (TCI) state to use for the at least one predicted beam blockage.

18. The first network node of claim 17, wherein the at least one processor is configured to:
transmit a communication to the third network node using the default TCI state for the at least one predicted beam blockage.

19. The first network node of claim 1, wherein the beam blockage prediction information includes:
beam blockage instance information including starting time information, duration information, severity information, blockage direction information, or a combination thereof for a future predicted beam blockage instance corresponding to the at least one predicted beam blockage associated with the at least one downlink serving cell;
the measurement information, wherein the measurement information includes at least one of reference signal receive power (RSRP) measurement information or parameters derived from the RSRP measurement information for the first network node;
identifier information for the first network node;
serving cell identifier information including respective identifier information for each respective downlink serving cell of the at least one downlink serving cell; or
a combination thereof.

20. The first network node of claim 1, wherein, to transmit the beam blockage prediction information, the at least one processor is configured to transmit the beam blockage prediction information via a sidelink channel.

21. The first network node of claim 1, wherein the at least one processor is configured to:
determine whether uplink pathloss information associated with the at least one downlink serving cell satisfies one or more conditions, wherein the transmission of the beam blockage prediction information is based on the determination, and wherein to determine whether the uplink pathloss information satisfies the one or more conditions, the at least one processor is configured to:
compare a first uplink pathloss value, for a first downlink serving cell of the at least one downlink serving cell, to a first uplink pathloss threshold associated with a first condition for the first downlink serving cell; and
compare a second uplink pathloss value, for a second downlink serving cell of the at least one downlink serving cell, to a second uplink pathloss threshold associated with a second condition for the second downlink serving cell.

22. The first network node of claim 21, wherein the at least one processor is configured to:
determine the first uplink pathloss threshold based on a payload size of the beam blockage prediction information.

23. The first network node of claim 1, wherein the at least one processor is configured to:
receive, prior to the transmission of the beam blockage prediction information, beam blockage prediction capability information from the second network node, wherein the beam blockage prediction capability information includes an indication of a beam blockage prediction relay capability of the second network node, an indication of a beam blockage prediction capability of the second network node, or both.

24. The first network node of claim 1, wherein, to transmit the beam blockage prediction information, the at least one processor is configured to transmit an aperiodic transmission including the beam blockage prediction information, and wherein the at least one processor is configured to:
transmit a scheduling indication to the second network node indicating the beam blockage prediction information.

25. The first network node of claim 1, wherein, to transmit the beam blockage prediction information, the at least one processor is configured to transmit a first semi-persistent transmission including the beam blockage prediction information, and wherein the at least one processor is configured to:
transmit a scheduling request for a plurality of semi-persistent transmissions including the first semi-persistent transmission to the second network node, wherein the scheduling request includes periodicity information and offset information for semi-persistent transmission of the plurality of a semi-persistent transmissions; and
transmit a scheduling indication for the beam blockage prediction information to the second network node based on the scheduling request after receipt of an acknowledge from the second network node or expiration of timer associated with the scheduling request.

26. A first network node for wireless communication, comprising:
at least one processor; and
a memory coupled to the at least one processor,
wherein the at least one processor is configured to:
receive, from a second network node via a sidelink channel, beam blockage prediction information, wherein the beam blockage prediction information is indicative of at least one predicted beam blockage for the second network node and is associated with at least one downlink serving cell; and
transmit the beam blockage prediction information to a third network node via an uplink channel.

27. The first network node of claim 26, wherein the first network node is configured to receive second beam blockage prediction information for other network nodes and relay the second beam blockage prediction information to the third network node.

28. The first network node of claim 26, wherein the at least one processor is configured to:
receive, from the third network node, a beam blockage response responsive to the beam blockage prediction information, wherein the beam blockage response includes information indicative of a modified transmission setting configuration for the second network node and a first identifier for the second network node; and
transmit a beam blockage response indication to the second network node based on the beam blockage response.

29. The first network node of claim 28, wherein the beam blockage response is included in downlink control information (DCI) or a physical downlink shared channel (PDSCH) transmission, and wherein the beam blockage response includes an identifier for the second network node.

30. The first network node of claim 28, wherein, to receive the beam blockage response, the at least one processor is configured to receive the beam blockage response via a physical downlink shared channel (PDSCH), and wherein the beam blockage response includes multiple beam blockage response indications associated with multiple network nodes.

31. The first network node of claim 30, wherein the at least one processor is configured to:
determine, based on the beam blockage response, a second network node identifier for a fourth network node, the second network node identifier associated with a respective indication of the multiple beam blockage response indications; and
transmit a second beam blockage response corresponding to the second network node identifier to the fourth network node.

32. The first network node of claim 28, wherein the beam blockage response indication comprises one or more transmission configuration indicator (TCI) state identifiers for the second network node, wherein each respective TCI state identifier of the one or more TCI state identifiers is associated with one or more respective control resource sets (CORESETs) associated with second network node.

33. The first network node of claim 28, wherein the beam blockage response indication comprises one or more beam failure detection (BFD) reference signal (RS) (BFD-RS) identifiers associated with the second network node.

34. The first network node of claim 28, wherein the beam blockage response indication comprises an adjustment to a periodicity of semi-periodic beam blockage prediction measurements or semi-periodic beam blockage prediction messages for the second network node.

35. A first network node for wireless communication, comprising:
at least one processor; and
a memory coupled to the at least one processor,
wherein the at least one processor is configured to:
receive beam blockage prediction information from a second network node via an uplink channel, wherein the beam blockage prediction information is indicative of a predicted beam blockage instance for a third network node; and
transmit beam blockage response information to the second network node via a downlink channel, wherein the beam blockage prediction information includes an indication for a beam blockage recovery operation for the third network node.
